(19) United States
(12) Patent Application Publication
(10) Pub. No.: US 2006/0029178 A1
(43) Pub. Date: Feb. 9, 2006

(54) Method and apparatus for the production of energy

(76) Inventor: A Christian Tahan, Arlington, MA (US)

Correspondence Address: Robert K Tendler, 65 Atlantic Avenue, Boston, MA, 02110, US

(21) Appl. No.: 10/537,532

(22) PCT Filed: Dec. 20, 2003
(86) PCT No.: PCT/US03/41096

§ 371 Date: Jun. 3, 2005

Related U.S. Application Data
(60) Provisional application No. 60/436,444, filed on Dec. 23, 2002.

(51) Int. Cl. G21B 1/00; H05H 1/22

(52) U.S. Cl. 376/100

(57) ABSTRACT

A proton held aligned in a sufficiently strong magnetic field maintaining the low energy state for the body can be decayed with cyclic 2 Hz radio waves to provide one of three types of energy: fusion, gravity waves and anti-gravity, and particle-antiparticle annihilation. New elements may also be formed as a result of the ability to rapidly decay protons at room temperature.

### FIELD OF THE INVENTION

This invention relates to enhancement of nuclei decay, more particularly to subjecting protons in the presence of a magnetic field to a 2 Hz radio wave to stimulate proton decay.

### BACKGROUND OF THE INVENTION

As is well documented, the half-life for the proton is predicted to be at least 10³⁵ years. According to J. A. Gowen regarding the half-life of protons, the Sun or like stars can achieve proton decay through the massive amount of fusion energy generated. On Earth such proton decay has not been seen or synthetically generated. In the process of proton decay, it has been theorized that protons decay to a neutron, a positron and an electron neutrino. Moreover in the presence of deuterium, it has been postulated that the decay of a proton can result in a helium-3 atom and a gamma ray, the same fusion process of the Sun. The process is an energy generation process.

The problem in the past for obtaining energy from such proton decay has for the most part centered around the inability to provide the required temperatures on Earth to induce proton decay.

If the energies associated with proton decay could be harnessed at room temperature, low temperature power generation would be possible along with the ability to provide such energy without massive shielding or containment vessels and the like.

While numbers of unification theories have been advanced, none has adequately observed the fundamental characteristic of mass, although the so-called Higgs field attempts to describe mass in terms of a mediating boson that is thought to have provided mass to fundamental particles. It is noted that, to the present date, the mediating boson has not been observed although its existence has been globally sought. One of the suspected reasons for the lack of observing the mediating boson has been the above-mentioned predicted half-life for the proton of at least 10³⁵ years. Moreover, proton decay has not been considered possible since it could violate conservation of baryon number.

In short, the predicted half-life of protons has inhibited whatever practical application could be made of proton decay. Certainly reducing the proton half-life at room temperature to less than 10³⁵ years has been a major obstacle.

### SUMMARY OF THE INVENTION

It has been found that with the application of 2 Hz radio waves to protons in a magnetic field, energy is released due to resulting proton decay. Thus, room temperature proton decay can be made to take place not in 10³⁵ years but in less than 360 seconds. Originally, 1-3 Hz was considered because of an unexplained presence of 1-3 Hz due to solar flare activity after interacting with certain planets. The 1-3 Hz energy was originally measured by satellite observation. 1-3 Hz radiation was concluded also to be generated by the Sun, which led to the supposition that the energy emitted would likely interact with protons at the Sun because of abundance in the corona. Because the Sun has a magnetic field the protons in the Sun are aligned. It was then supposed that by aligning protons with a magnetic field to place them in their low energy state as at the Sun, introduction of 1-3 Hz would add energy causing the protons to become unstable and decay. The notion of use of the 1-3 Hz was thought logical since NMR uses MHz frequencies to move protons out of alignment, whereby a lower frequency would not move the protons at all but simply perhaps would be absorbed. It was then found experimentally that the protons decayed within 360 seconds on average at 2 Hz as opposed to 10³⁵ years.

Proton decay leads to the release of energy, in one form in the generation of a gravity wave. The energy released may be used directly for power generation and the like, or new elements can be made by the adding of protons to a nucleus. Thus, it is possible to create elements, including elements with differing neutron numbers (isotopes) since elements maintain stability naturally by creating neutrons, positive beta decay. With the ability to generate proton decay, the subject technique includes creating new elements for the periodic table.

Thus, when protons are situated in a magnetic field with a 2 Hz radio wave, with the antenna in line with nuclei, one can create one of three types of energy through the artificially-induced proton decay.

Not only is a fusion reaction between deuterium and protons possible, the subject technique involves the generation of a gravity wave that is responsible for both the imparting of energy and the increasing of mass of an object when a gravity wave passes through. Additionally, it will be shown that the gravity waves have a spin-2 property. Moreover, particle-antiparticle annihilation involved in the proton decay process is a third source of energy.

More particularly, protons are decayed in the presence of a magnetic field and a periodic 2 Hz radio wave injected adjacent to protons to provide one of three types of energy production through artificially-induced proton decay: namely fusion, production of a gravity wave with anti-gravity, and particle-antiparticle annihilation. As mentioned above, new elements may also be formed.

The first type of energy production involves in one form the fusion of deuterium atoms and protons to provide helium-3 atoms and a gamma ray yielding 5.4 MeV.

The second type of energy produced includes the production of a gravity wave at room temperature through the decaying of a proton aligned in a magnetic field in the presence of a 2 Hz radio wave. The decaying of this proton produces a neutron, a positron, and an electron neutrino in less than 360 seconds due to the repeated 2 Hz signal, as opposed to 10³¹⁻³⁵ years previously predicted for natural proton decay. Once formed, the neutron decays in milliseconds into a reduced or unstable gluon that adds to what is left of the final 2 Hz radio wave that interacted with the body to create a gravity wave, the reduced gluon fusing to the radio wave allowing the gravity wave to propagate. Its nature obeys the inverse square law. The total possible energy associated with one gravity wave is approximately 1.11×10³-1.11×10⁴ GeV.

The third type of energy produced includes particle-antiparticle annihilation. The proton decays to the aforementioned neutron, positron and electron neutrino and in one form the positron and an available electron annihilate producing 1.02 MeV.

The energies generated from proton decay require no heat input as would be typically required for fusion as in the proton-proton chain reaction, which requires the heat associated with plasma reactions. Total possible fusion energy produced from a reaction volume of approximately 2 mL is 1.1×10²⁰ MeV/sec-cm versus 1.6×10¹⁵ MeV/sec-cm for current fission reactions, a five order of magnitude improvement over the most productive commercial energy production method today. Note with the subject process there is no heat required and there are no radioactive byproducts, with the output being scalable.

The energy produced is easily incorporated in present electricity generation plants while maintaining the same method of generation in that the energy can be used to heat water to produce steam without having to provide additional shielding of any containment vessel or core. This is because stainless steel will shield the aforementioned gamma rays. Thus, the subject technology in one form is an energy production system of high efficiency. The system is expandable with regulating software or other components even at endpoints where production from power plants is consumed.

If the source of protons for the method is from the reaction of sulfuric acid with copper, the exhausted sulfuric acid can be recycled without the requirement of the disposal of any nuclear waste. Thus, the method of energy production when incorporated in present power plants is environmentally advantageous since nuclear fuels as uranium, Plutonium, or Thorium are not needed and the need for fossil fuels is eliminated.

In one embodiment, the amplitude of the 2 Hz radio wave is between 12 and 12.5V. Control of the reaction can be accomplished by switching the 2 Hz radio wave from core partition to core partition when a partition reaches a predetermined temperature to prevent overheating.

In addition to energy generation, a gravity wave imparting energy on a mass increases the mass of the object in accordance with E=mc².

The production of gravity waves to increase the mass of an object onto which the gravity waves impinge may be used, for instance, for hurricane control in which droplets in hurricane funnels are increased in mass thus depressing the hurricane to destroy it.

Alternatively, rain clouds may be made to emit rain by irradiating the rain cloud with gravity waves thus to increase the weight of the individual droplets, whereupon they fall to the earth as rain.

The production of the gravity wave can also be used in quantum computing since the wave is a spin-2 body and can be used for medical and laboratory applications, in one application to replace the polymerase chain reaction utilized to replicate DNA since DNA is naturally negatively charged, i.e. can be aligned in a magnetic field. When exposed to the 2 Hz signal with the DNA aligned in a magnetic field, the DNA breaks apart. Alternatively, one can direct the 2 Hz radio wave to a biologic body to add components as DNA or other molecules or components by adding the compatible component that is in close proximity to the biologic body, which is altered through radiating it.

### BRIEF DESCRIPTION OF THE DRAWINGS

These and other features of the subject invention will be better understood in connection with the Detailed Description, in conjunction with the Drawings, of which:

FIG. 1 is a diagrammatic illustration of the subject process in which protons are subjected to 2 Hz radio waves when placed between the poles of a magnet;

FIG. 2 is a listing of the types of reactions to provide fusion, a gravity wave, and particle-antiparticle annihilation for producing energy from the decay of protons utilizing 2 Hz radio waves and a magnetic field;

FIG. 3 is a diagrammatic illustration of the use of proton decay in the generation of steam for electricity production showing the utilization of a bath of sulfuric acid, the positioning of the bath of sulfuric acid in a vessel positioned between magnetic poles, the utilization of a 2 Hz radio wave antenna, the generation of protons through the utilization of a copper wire sink to remove electrons, coupled with a water supply and water jacket around the container for removing the heat generated;

FIG. 4 is a diagrammatic illustration of the control of the process of FIG. 3 through the control of the application of the 2 Hz radio wave to a series of vessels, with the 2 Hz radio waves removed when the temperature of a vessel exceeds a predetermined threshold;

FIG. 5 is a diagrammatic illustration of the generation of a gravity wave directed to a mass that increases the mass of the object irradiated by the gravity wave;

FIG. 6 is a diagrammatic illustration of quantum computing utilizing the spin-2 characteristic of a gravity wave;

FIG. 7 is a diagrammatic illustration of the utilization of the spin-2 gravity wave process to break apart DNA that acts as a PCR substitute, in which the separated strands of the DNA may be provided with an altered gene sequence in a coming together/binding process;

FIG. 8 is a diagrammatic illustration of an experimental set-up using one magnet to produce room temperature proton decay;

FIG. 9A is a diagrammatic illustration of the FIG. 8 machine incorporating photographic film wrapped around the proton containing Pyrex tube that was developed with convention methods in a darkroom;

FIG. 9B is a diagrammatic illustration of a photograph which is the result of experiments using the apparatus of FIG. 9A that presents evidence of the Higgs field in that the presence of the field allows appearance of the reduced radio wave and reduced gluon;

FIG. 10 is a diagrammatic illustration of an experiment utilizing two magnets;

FIG. 11A is a diagrammatic illustration of the FIG. 8 setup incorporating a germanium detector that recorded nuclei decay activities;

FIG. 11B is graph of germanium detector energy versus-counts of output from the FIG. 11A apparatus, which shows evidence of nuclear decay activity during the process of energy production in the apparatus of FIG. 8;

FIG. 12A is a diagrammatic illustration of the FIG. 8 machine with the addition of tungsten powder for fusion experiments, illustrating running of a sample from trials on a Differential Thermal Analysis machine; and,

FIG. 12B is the output graph of a Differential Thermal Analysis from the DTA machine of FIG. 12A showing what elements the examined sample contained indicating the successful addition of protons onto tungsten nuclei through fusion to produce the elements represented by the peaks.

### DETAILED DESCRIPTION

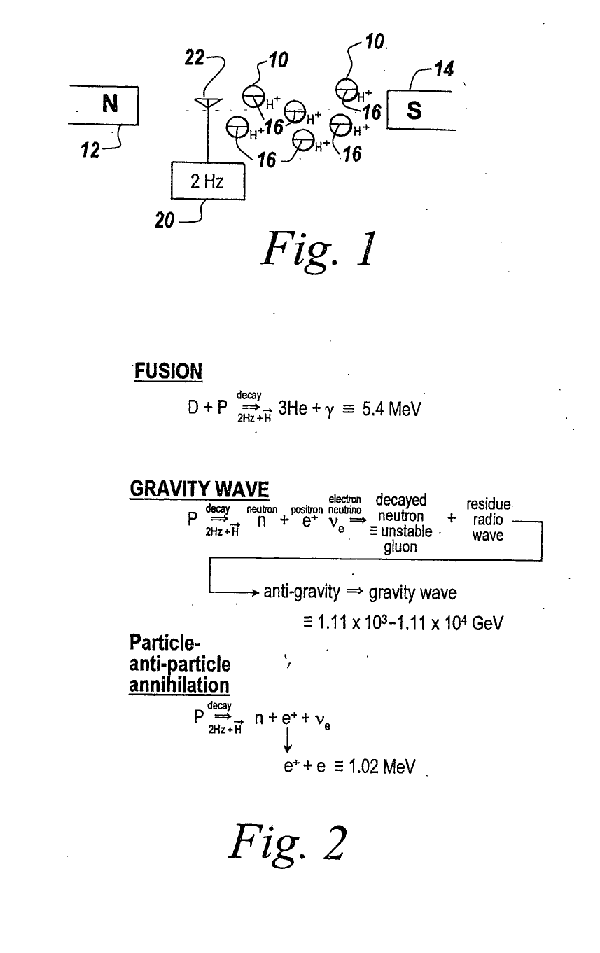

Referring now to FIG. 1, the ability to decay protons at room temperature in seconds as opposed to 10³⁵ years is accomplished by placing protons 10 between the poles 12 and 14 of a magnet that orients each of the protons so that they are aligned as illustrated by lines 16 all in one direction along the magnetic lines of force between the magnetic poles. A 2 Hz radio wave is generated by a generator 20 which radiates the 2 Hz signal via an antenna 22, which in one embodiment is simply a copper wire.

As mentioned hereinbefore, it has been found that the 2 Hz radio wave promotes decay in under 360 seconds as opposed to 10³⁵ years. The result of the proton decay as illustrated in FIG. 2 is to provide the release of energy in three forms: fusion, a gravity wave and particle-antiparticle annihilation.

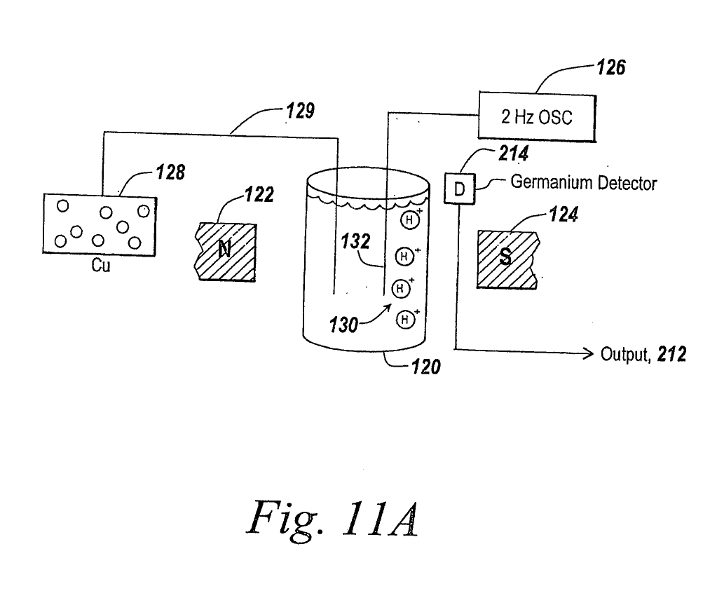

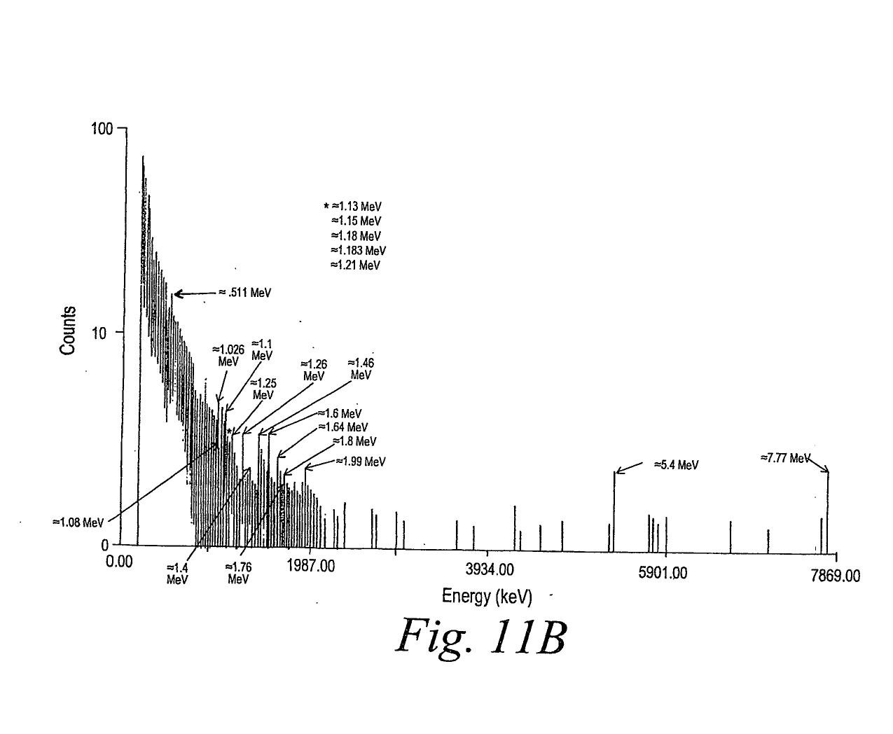

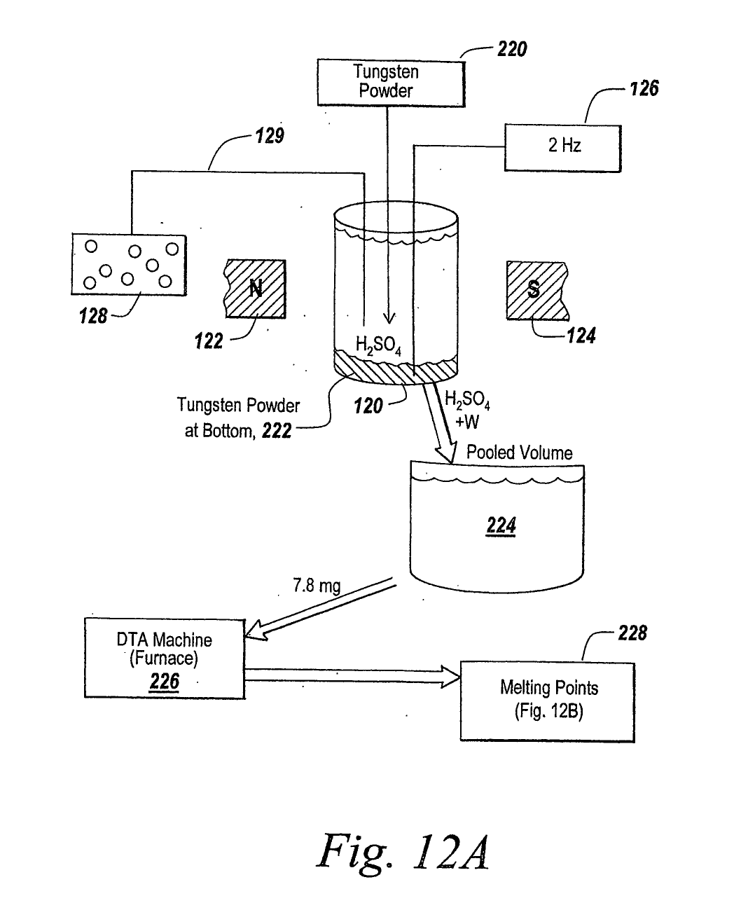

As can be seen, through the application of the repeated 2 Hz signal and the magnetic field, when a proton is decayed in the presence of deuterium a fusion process ensues resulting in a helium-3 atom and a gamma ray. The energy release for this fusion reaction is 5.4 MeV. This release was observed in the experiment described in connection with FIGS. 11A and 11B.

As to the generation of a gravity wave, a proton in a magnetic field decaying in the presence of the periodic 2 Hz radio wave results in a neutron, a positron and an electron neutrino. With the decay of the proton one obtains the unstable gluon. In the presence of a residual radio wave left over from the decay-inducing process, this results in a gravity wave with a spin-2 characteristic and antigravity. Antigravity exists at the point of union of the radio wave and the reduced gluon in that it was a released body that stayed in place as the gravity wave traveled away. Note, the type of energy associated with the gravity wave is 1.11×10⁴ GeV.

A third source of energy in the decay of the proton is particle-antiparticle annihilation. In one form, the proton under the influence of the 2 Hz periodic radio wave and the magnetic field provides a positron, which when colliding with an electron produces 1.02 MeV.

Note that in experiments the amplitude of the 2 Hz wave was 12.0-12.5V, whereas the magnetic field was 2000 Gauss. Note also that the amplitude of the interaction can be increased or decreased depending on the area of the interaction. Also, a simple timer circuit may be used to produce 2 Hz square waves.

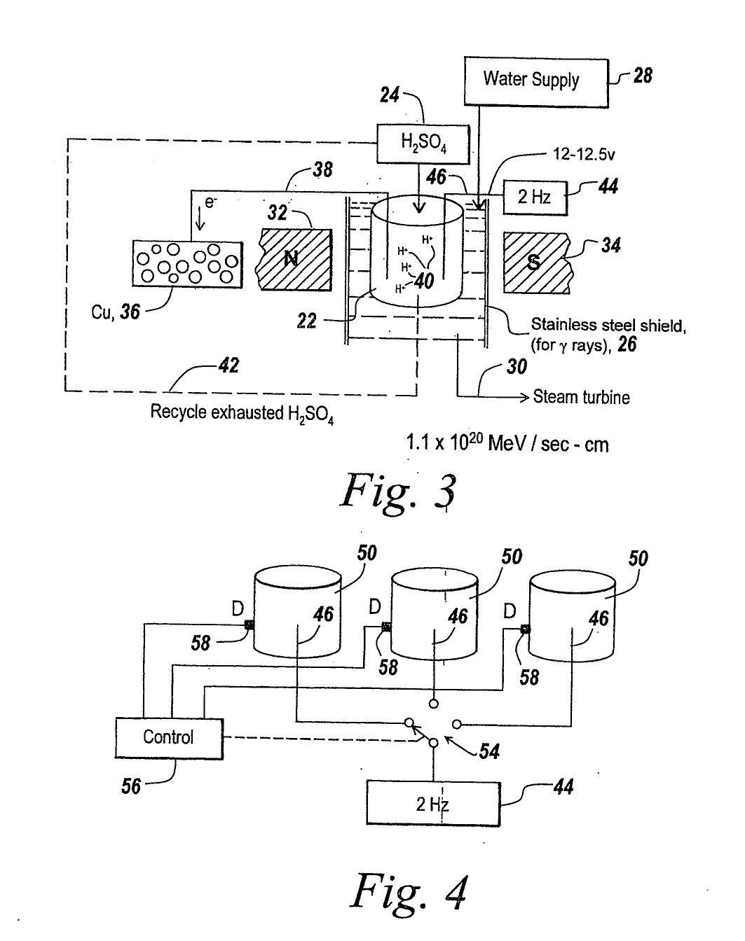

Referring to FIG. 3, one type of practical system for taking the energy and using it to convert water to steam, especially in a power plant, involves the use of a container 22 filled with sulfuric acid from a sulfuric acid source 24. Note the sulfuric acid can be manually replaced after each use. In one scenario, the container is located within a stainless steel shielded water jacket 26, with the stainless steel shielding for the aforementioned gamma rays. Additional shielding can be implemented by surrounding the stainless steel with a covering of inexpensive and readily available lead.

Water from a supply 28 passes through the stainless steel-shielded jacket and exits as steam as illustrated at 30, which is provided to a steam turbine.

The sulfuric acid container exists between the poles 32 and 34 of a magnet, with a copper wire 38 being inserted into container 22 and connected to a copper sink 36 filled with copper pellets. It is the purpose of the wire with the sink to remove electrons from the sulfuric acid, thus to leave protons indicated at 40. The reaction of the H₂SO₄ with the copper is a good source of protons, with exhausted H₂SO₄ recycled as illustrated by dotted line 42 back to reservoir 24. Note, complete removal of the electrons is not a hindrance to the procedure of proton decay in that hydrogens containing electrons, not protons alone, can still decay to lead to the aforementioned energies.

Note also that a 2 Hz source 44 that may be a function generator provides the periodic 2 Hz radio wave through an antenna wire 46 adjacent the protons. As will be seen, the interaction zone depends on the length of the wire.

It has been calculated that the overall energy production of such a system is 1.1×10²⁰ MeV/sec-cm considering the use of 2 mL of sulfuric acid as described in the experiment of FIG. 8. Note all atoms in the volume fuse simultaneously. The energy output is five orders of magnitude greater than the energy associated with fission reactors. The simultaneous fusing is made possible simply by exposing all atoms to the 2 Hz signal. As to the antenna wire, it is noted that the amount of reaction depends upon the amount of wire 46 providing the signal to vessel 22 holding the protons, in that the longer the length of antenna into a spaced volume the more protons will decay simultaneously. Thus, in FIGS. 3 and 4, the length of antenna 46 determines various reaction times.

With the reaction being such as to generate the amounts of heat indicated and referring now to FIG. 4, in order to control the heat generated, a number of jacketed vessels 50 are provided with 2 Hz antennas 46 that are controlled by a switch 54 under the control of a unit 56. Heat detectors 58 are positioned at jacketed vessels 50 so that once a predetermined heat level has been reached, switch 54 is moved to switch 2 Hz radio waves to the next vessel. Continuous energy production is maintained with this procedure since the production of fusion is periodic in that one vessel produces energy while the others cool or are in the process of energy generation.

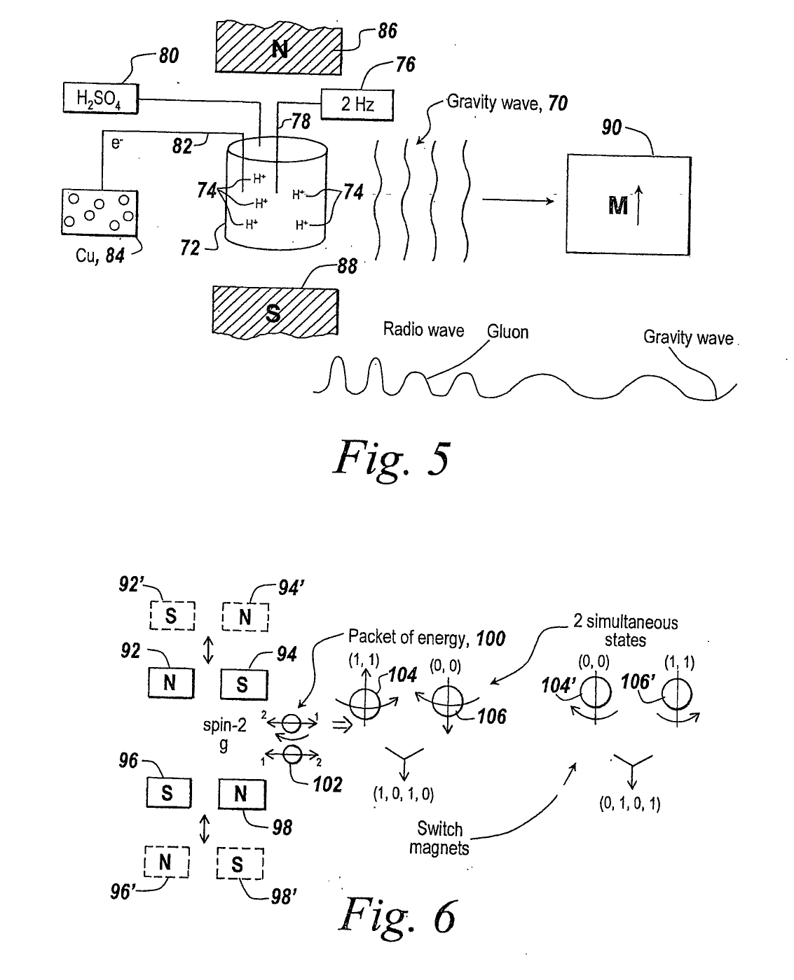

As mentioned hereinbefore, the subject system generates a gravity wave 70 as illustrated in FIG. 5 that is produced when a vessel 72 of protons 74 is provided with a source 76 of periodic 2 Hz waves that are transmitted down via a wire 78 such that the waves are projected towards vessel 72. Note the wire does not necessarily have to be inserted in the vessel, although in experimentation the antenna was in the medium for convenience and to ensure that the 2 Hz would be contacting the protons.

To produce the protons in the manner described in FIG. 3, a source 80 of sulfuric acid is provided for vessel 72, with a copper wire 82 providing a conduit for electrons to be sinked at a pulverized or pelleted copper sink 84. Vessel 72 is surrounded by poles 86 (N) and 88 (S) of the magnet that produces the gravity waves as described in connection with FIG. 2. Upon the impinging of a gravity wave on mass 90, the mass of the object is increased.

In terms of quantum computing and referring to FIG. 6, an understanding of spin-2 is helpful. Spin can be thought simply as the orientation of a packet of energy (quanta). The positioning of the energy can be described with arrows in that the direction to which an arrow is pointing indicates the orientation of the quanta. Spin-2 can be described as a two-headed arrbw in that it simultaneously occupies two positions. Thus, if a spin-2 body were rotated 180° it would not appear as though it had changed orientation.

The difference is understood when compared to a spin-1 body, which can be described as a one-headed arrow. This description is presently used in quantum computing studies. A spin-1 body would have to be rotated 360° before the appearance would seem unchanged. As to spin-1/2 bodies, these bodies would have to be rotated 720° before returning to original states.

In FIG. 6, when an alternating magnetic field 92, 94, 92′, 94′, or 96, 98, 96′, 98′ rotates the aligned packet of energy 100 as illustrated by spin-2 body 102 and particularly prior to 1/d² travel, the result is appearance of altered states 104 and 106. Rotation counterclockwise provides appearance 104 of a dual state assigned 1,1 while clockwise rotation would present the opposite 106 dual state 0,0 or vice versa as observed with 104′ and 106′. Thus, the body is a controllable four-packet system, spin-1 being a two packet system. The four-packet system yields a binary encoding scheme that can interact with other manipulated spin-2 bodies for various applications. This system produces data at an unparalleled rate due to there being no speed of light constraint. For example, the spin-2 quantum system allows for enormous advances, for instance for improved drug development, calculations, greater advances in algorithm development, advances in encryption schemes, advances in software, new coding languages for programming spin-2 quantum systems, more precise medical imaging, or for general uses as in gaming. More specifically, hybrid computers could be made in that the quantum system could be incorporated with present hardware to create advanced intermediate products.

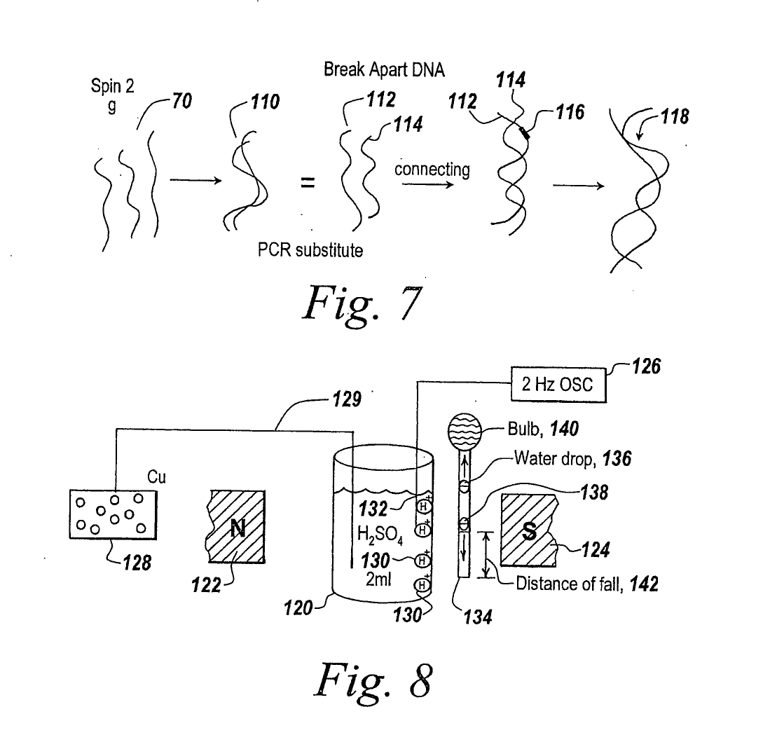

Referring now to FIG. 7, assuming a spin-2 gravity wave 70 impinges upon a DNA molecule 110, the energy imparted to the helix causes the helix to break apart as illustrated at 112 and 114. This process is similar to PCR but is more energetic than the conventional method of temperature increase to break apart DNA strands. Thereafter, combining results in the strands 112 and 114 being provided with a new genetic code or marker 116. The DNA thus is replicated as illustrated at 118 to provide DNA of a different genetic code.

What is described is the creation of a new body in that close proximity of the genetically compatible body during irradiation allows the new form to be incorporated. The technique is like fusion in that the energies become shared so that to maintain stability they become one body. The process is like PCR in that oligonucleotides or similar strands of nucleic acid can be added to the irradiated strands that break apart so that the bodies can be replicated. Also, the breaking apart of the strands may be achieved with simple irradiation with 2 Hz, rather than with the gravity wave in that the process allows for the same breaking apart. Alternatively, electromagnetic energy at different frequencies may be found to work better in creating breaks depending on the biological body to allow for addition. Additionally, nonbiological bodies designed to be compatible can be added to the biological bodies for functionality.

For example, an element from the periodic table or an engineered body could be added to a nucleic acid base or between bonds to allow for the new body formed to perform a specific task. The application allows for numerous possibilities for combinations as in adding electronic components for computing. In this case, the body can be stimulated to action by outside control as for drug delivery or other medical applications as to stimulate replication, translation, or RNA editing. The subject invention can achieve profound results in altering a structure such as a cell to prevent a virulent from entering that would potentially prevent the spread of disease.

For example, a body could first be injected. When in close contact the structure needing altering can be radiated so that the injected body can add, with the new structure providing the initially intended functionality. Genetic engineering is achieved as with such a procedure since in one form the new form can be stimulated to replicate with the subject technology so that it could replace damaged bodies such as T cells that may not have been in sufficient number and that may have been related to or the reason for an illness.

The method is not limited to DNA in that other biological bodies or nucleic acids specifically could be used. Also, the PCR process can work directly in a human being or other organism in that irradiation can be directed to a specific area of the body for the process to occur in a cell or tissue, especially if the DNA of the tissue needs altering to alleviate disease.

In other words, targeted injection of the 2 Hz radio wave or of gravity waves into cells or tissue in an appropriate magnetic field can alter cells or tissue for diagnostic or treatment purposes as by altering bonds or positioning of components in tissue or altering DNA in cells. Use directly on a body could be considered a means for creating cell signaling or for tissue engineering in that the process could allow tissues to interact similarly to the quantum interacting process of FIG. 6 so that the process may allow for tissue growth, e.g. bone or other tissue stimulation to allow for repair.

In fact, gravity waves can be used to allow a tissue to form properly with dimensionality that would eliminate the need for burdensome scaffolding in that damaged tissue could repair itself by being subjected to external waves with spin-2. This procedure eliminates the need for transplants.

The use of the subject system is not limited to a specific tissue in that blood vessels too may be stimulated, angiogenesis, or potentially redirected or prevented from growing in cases that may require a cessation of blood flow as to eliminate tumors. Thus, the subject system could be used to engineer specific biological bodies as proteins/growth factors, enzymes, carbohydrates, or fats.

Apart from physiology, if desire for a product as a specific coffee bean, salt, or diamond was great though difficult to attain, it could be engineered with the subject technology similarly to the process of FIG. 7. Additionally, when understanding that genetic engineering is possible with the subject system new species may be created. For example, the subject system can be used to create a new virus or bacteria species for injection or directly in a host. The new species could potentially act as a competitor or predator to an undesired virus or bacteria, thereby eliminating the disease. In one form, the new species could be created easily internally by directing the gravity waves on the undesirable pathogen to cause it to mutate to the new species that could eventually eliminate the disease. This strategy could be used for common conditions as colds or the flu, apart from simply irradiating the causes of such ailments with 2 Hz and a magnetic field or gravity waves.

Interaction between tissues through the process could lead to new synapses, and the process may provide help in reproduction in that embryonic or fetal growth may be stimulated, maybe most useful if damage is observed in that the process may be a last attempt to stimulate growth. Thus, the subject system can be viewed as a potential alternative to abortions, considering that some women have them due to potential birth defects. The process could be utilized also for premature births to allow for proper development of the new born. Also, tissue that may have had trouble in working properly may be stimulated to action. For example, ovaries could be stimulated to release eggs, or nonreproductive organs as the pancreas may be stimulated for insulin production.

Regarding medical imaging, as will be described in FIG. 8, the system can constitute a new form of medical imaging device in that biological bodies placed in the magnetic field and subjected to the 2 Hz could be observed in relation to how the body reacts to the electromagnetic energy. In other words, diseased structures could respond differently as moving in an unusual manner compared to normal tissue so that the observation would make the unusual structure apparent. The same technique could be used in microscopy in that the machine would not simply be a tool for medicine but could be used in laboratory applications for visualizations.

FIG. 8 specifically was the set-up used for the majority of trials. Here water droplet and pipette movements were the measurements confirming the existence of the gravity wave and anti-gravity. In this seminal experiment, protons were decayed at room temperature in seconds by placing protons 130 between the poles 122 and 124 of a magnet that oriented each proton so that it was aligned in the direction of the magnetic field from pole 122 to pole 124. The protons were created with use of sulfuric acid (H₂SO₄) placed in the Pyrex tube container 120. A copper wire 129 was inserted in the acid of container 120 with the other end inserted in a silk of pulverized copper 128. The process of electron generation is the same as in a car battery with the addition of the notion that wire 129 directs the electrons, separated in container 120 with the insertion of wire 129, to the multi-positively charged sink 128.

A 2 Hz radio wave was generated by a 2 Hz oscillator 126 coupled to an antenna 132 to radiate the 2 Hz signal. In one embodiment, antenna 132 is simply a copper wire. A Pasteur pipette 134 held water drops 136 and 138 with the aid of a pipette bulb 140. The drops were in-line with antenna 132 so that the forces produced from the decayed protons would affect the drops.

Anti-gravity was observed in that drop 136 was moved upward before returning to its previous position, whereupon the drop was influenced by the gravity wave. Note that the gravity wave was found to influence the drop after anti-gravity. The influence of the gravity wave is illustrated by descending drop 138. Having many drops in pipette 134 allowed for continuous observations. It was observed that a drop did not return to its previous position after having been influenced. This is because it may have moved upward or fallen far enough to be out of the influence of anti-gravity or the gravity wave respectively. Thus it would not return to its previous position as typically after the influence on the drop no longer existed.

It was then concluded that the downward motion of the drops corresponded to the increased drop mass due to the passage of the gravity wave through the drop. Another way of explaining this phenomenon is to consider that additional acceleration was added apart from gravitational acceleration due to the mass of the Earth.

Alignment was achieved by using the center of pole 124 marked with a hole, as a guide. The drop fall distances 142 were measured to allow for vector addition calculations. Also, pipette movements away from and toward container 120 were noted as being the result of the effects of anti-gravity and gravity. Trials varying the distance of the pipette from container 120 confirmed that the movements toward the tube were in accordance with the inverse square law. These experimental findings explain the nature of gravity waves, i.e., that the gravity wave amplitude decreases with the square of the distance. The trials also showed that the force of anti-gravity was not governed by the inverse square law. The upward drop movements were initially thought to be the same distance as the drop falls. Thus the forces involved were thought to be governed similarly, until the pipette distance trials were performed. The drop fall distances were maintained, though the movements upward were decreased, becoming nonexistent with increasing distance of the pipette from the tube. The results of the pipette distance trials from the Pyrex tube were the first observations to suggest the notion that anti-gravity influenced in place rather than traveling like a gravity wave.

The machine of FIG. 8 has numerous applications. As will be seen in experiments described hereinafter, the machine of FIG. 8 can be used for fusion. In that experiment, elements were created from tungsten. Also, new elements can be created to be added to the periodic table. Additionally, the machine of FIG. 8 produced anti-gravity that has numerous applications as in the alleviating of mass or the pushing away of objects. This notion is because it was observed that the pipette was pushed away from the Pyrex tube through the influence of the anti-gravity force. Success in creation of gravity waves and anti-gravity occurred because the magnetic field and the 2 Hz radio wave produced room temperature decay of the proton.

The FIG. 8 machine can be considered the basis for new engines. The energies from fusion, gravity, anti-gravity, and particle-anti-particle annihilations can be used as fuel in that the heat generated from the machine can replace present systems of heat production as in fission engines used in submarines and the like, or even in internal combustion engines. The temperature decrease accompanying anti-gravity could potentially prevent engines from over-heating. Or the forces generated with the machine of FIG. 8 could propel vehicles by simply causing the conveyance to be pushed or pulled due to the respective created force. The push or pull benefit could be most useful in space travel since factors as friction on Earth do not exist in space. Also, the energies from the FIG. 8 machine can be directed and used for manufacturing, even for nano or smaller technologies. This is because in the production of gravity waves, protons are decayed. Moreover, the baryons and their components are manipulated by the subject process in that new bodies are created through fusion.

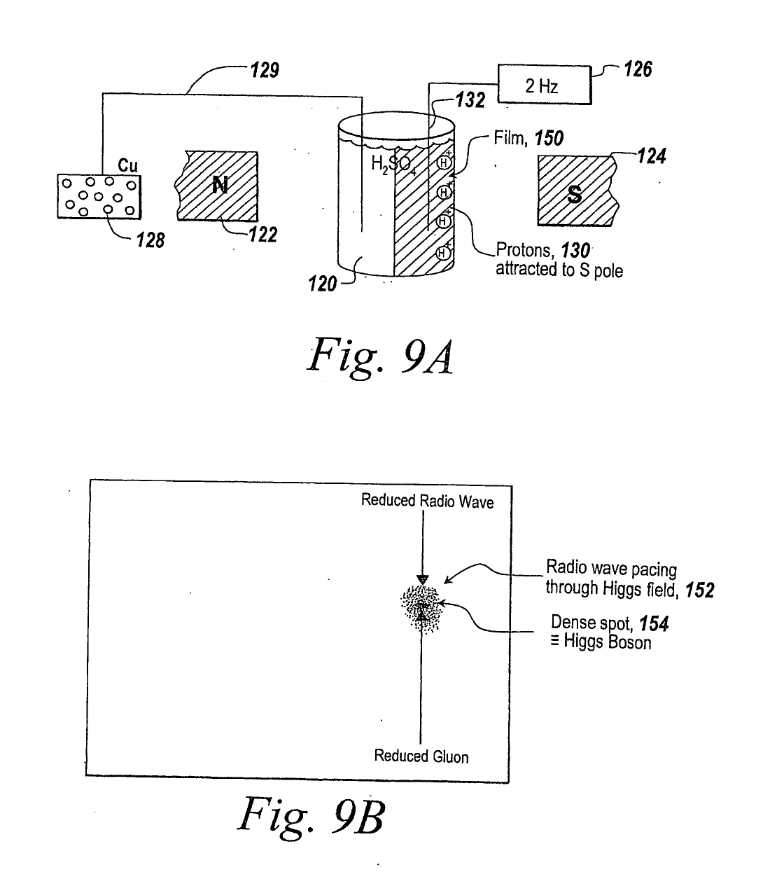

FIG. 9A shows another experiment to confirm proton decay leading to gravity and anti-gravity. In this experiment the machine of FIG. 8 incorporated photographic film that allowed for capturing of the Higgs field observed in FIG. 9B. The results of the FIG. 9A experiment confirm for the first time the existence of the Higgs field. In this experiment a Pyrex tube container 120 is located between the magnet poles 122 and 124, with a 2 Hz generator 126 coupled to an antenna 132 decaying the protons 130 that are typically attracted to the S pole. A copper wire 129 removes the electrons to the pulverized copper sink 128. The photographic film 150 was wrapped around the tube, and the protons were attracted to the S pole of the magnet, confirmed since decay or the Higgs field was only observed on the S pole regions of the films.

Referring to FIG. 9B, the photographic print taken during the experiment is evidence of the Higgs field. The dark point 154 is the result of the production of a reduced gluon, which is 1:1 correlatable to observation of the Higgs boson that happens to be in the field due to decay. The area labeled as the reduced radio wave shows a radio wave 152 having passed through the field. It can be determined that the field gave the radio wave energy (mass) so that it was captured on the photographic print. When the reduced gluon and the reduced radio wave combine, the Higgs field no longer exists, with only the Higgs boson and the anti-Higgs boson staying at the same point where the reduced gluon and the reduced radio wave merged.

The Higgs boson and the anti-Higgs boson stay at the same point because they are too massive to travel. Thus, they release energy in place. The release of anti-Higgs boson energy is the reason for the observed anti-gravity; and release of Higgs boson energy is the reason for the creation of elementary particles with masses. Thus, the subject system is a method for creating elementary particles.

The Higgs boson is not part of a gravity wave. If it were, the gravity wave would not be massless in that it would not obey the inverse square law. Since the gravity wave is energy, it is equivalent to mass when passing through bodies.

The observation of the gravity wave is evidence that the Higgs field exists. In other words, the Higgs field is the last attempt of the proton to exist. It is thought that the proton reached out and shared its energy with whatever came close to it. When energy is shared sufficiently, the bodies are no longer separate, they are one, which is the concept behind fusion. Thus, the evidence of the Higgs field on the print is a presentation of one Force in that the Higgs field is sharing energy with the reduced radio wave so that the reduced radio wave (electroweak interaction) and the reduced gluon (weak-strong interaction) are one body (strong-electroweak interaction). Weak is an indication that the bodies are decayed in that the gluon is in a reduced state (equivalent to weak force) and the reduced radio wave can be seen since it too is in the reduced state. Thus, the Higgs field appears momentarily prior to the bodies completely fusing, corresponding to one Force equivalent. When the bodies unify, the bosons become separate and stay in place as the new body gravity wave travels away from the point of union.

The Higgs boson and the anti-Higgs boson do not cancel each other out because as in particle-antiparticle annihilation particles, antiparticles must collide for annihilation. By that, they travel, meet at a point, and destroy each other releasing internal components. The Higgs and anti-Higgs boson are too massive to travel. In other words, they cannot travel and thereby cannot collide with each other. If it were to happen, or one could potentially make it happen, the energy release would be enormous and instantaneous. The release could be useful if harnessed or otherwise destructive particularly if creating multiple collisions simultaneously since the energy output would be the combination of the energy from each boson: 352.4 GeV+352.4 GeV=704.8 GeV.

Instead, the bosons are extremely close being essentially at the same point, and they release energies separately, i.e., anti-Higgs are observed with anti-gravity and Higgs are observed with new particles. Though production of energies has been primarily indicated in three forms, all energies as related to the bosons created through the machine of FIG. 8 are considered represented by the three forms mentioned in that they are not considered separate. Rather they occur as part of the creations of gravity/anti-gravity, fusion, and particle-antiparticle annihilations.

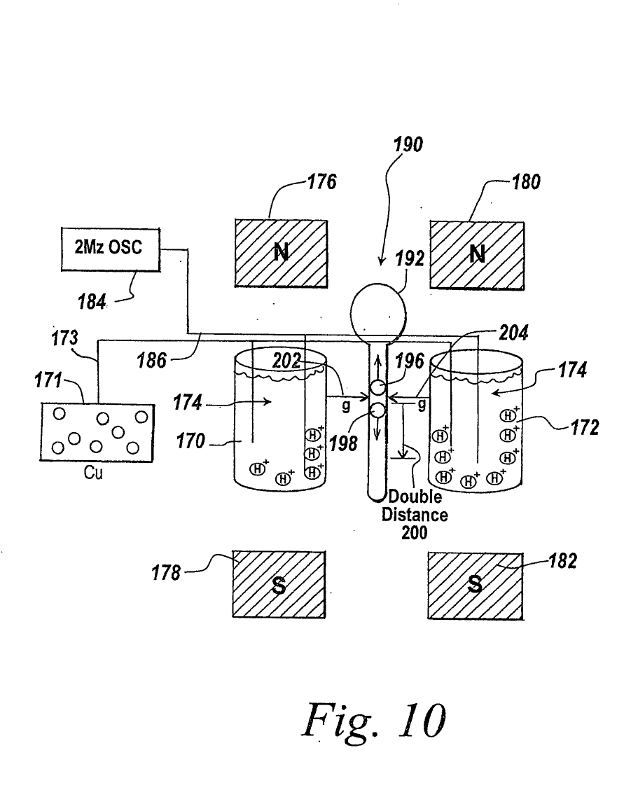

With reference to FIG. 10, the diagram represents a further experiment to ascertain if gravity waves are additive. Here a dual set-up is involved in which two FIG. 8 machines are used with the pipette positioned between the set-ups to measure any increased effect. Using separate magnets, multiple waves with spin-2 were generated. Force probe trials confirmed that multiple waves with spin-2 were produced simultaneously. In this experiment there are two tubes. The first set-up has a first tube container 170 holding the protons 174 between magnet poles 176 and 178 with the insertion of a copper wire 173 leading to a copper sink 171 to eliminate the electrons from the container. A 2 Hz oscillator 184 generated the frequency that was carried by copper antennas 186 to container 170 and to a second tube container 172 between magnet poles 180 and 182. Copper wire 173 also enters tube 172 and functions as a bridge to copper sink 171 to allow for electron removal. Removal of electrons completely is not a requirement since hydrogens with one electron each could exist in the tubes rather than the hydrogens being protons alone. The typical hydrogens would still decay and affect a pipette 190 holding water drops 196 and 198 with assistance from a pipette bulb 192. Numerous drops were placed in the pipette so that a drop would be aligned with both of the antennas 186 in the tubes. This pipette was aligned with both antennas to allow for both gravity waves to act on the droplets in the pipette and to crease a force on the pipette.

The 2 Hz was generated as before. The antennas were the same distance from the tube walls, and the set-ups were equally distanced from the pipette. As a result, the gravity waves were produced simultaneously to affect drops with the same energy values. The distance of drop falls 200 were measured showing that the dual set-up led to double the distance of drop falls. The doubling was confirmed through one magnet trials with the magnet being the same distance from the pipette, and with the single magnet maintaining the same orientation. Movement of the pipette seemed more visible since it was under the doubled influence of gravity waves and anti-gravity, which led to a doubling of the upward drop movement distance. The increased distance was the result of multiple productions of anti-gravity directed to the drops rather than anti-gravity having a shared character with gravity. The theory of operation was confirmed with the one magnet trials in which anti-gravity influence did not appear as gravity observations.

Note that the magnet orientation was vertical as compared with the horizontal orientation of the apparatus in FIG. 8. The vertical orientation permitted directing the gravity waves toward the drops. It was found that the drops followed the same form of upward movement prior to a return to their initial position before the gravity waves caused drop falls.

Using the arrangement of FIG. 10 resulted in observed pipette movements and proved the notion that gravity waves and anti-gravity can be directed to move objects. Also, the results of the FIG. 10 experiment confirmed that the forces involved could be directed on bodies for other purposes. For example, the gravity waves can be directed on pathogens to cause the bodies to implode or be destroyed due to the pressure from the waves. Additionally, the directing of waves could be performed with implants in that the forces could be created internally to allow for time released stimulation as for tissue growth or the periodic release to help fight diseases. Also, the notion of producing large gravity points as in creating synthetic black holes was confirmed possible, and the directing of the forces produced by anti-gravity and gravity waves can be used in engineering to test the strength of structures or even for demolitions.

Further, the FIG. 10 experiment confirmed potential use in wireless communications in that the waves can be directed over great distances. By that, in the FIG. 10 trials, the pipette was nearly twenty times the distance from the magnets compared to the FIG. 8 trials. The results proved that an effect can be produced over distance. Thus, the energy can be received and used at a location a distance away from the production. For example, a gravity wave can be directed from a satellite to provide power from the energy to a town or for uses as mentioned previously as with creating rain or purifying bodies of water.

With respect to the experiment described in FIG. 11A, this experiment confirmed fusion and the production of different elements when using the magnetic field and the 2 Hz radio waves. Note that the FIG. 11A set-up tracked the orientation of the FIG. 8 set-up. Here a Pyrex tube container 120 held protons 130 between the magnet poles 122 and 124. A 2 Hz oscillator 126 generated the frequency that was carried by copper antenna 132, while copper wire 129 led to copper sink 128 to allow for removal of the electrons. A germanium detector 125 was positioned adjacent tube 120 as well as possible at S pole 124. Germanium detector 125 was used to record activity from proton decays, with the output 212 from one trial presented as FIG. 11B. The FIG. 11A setup was the same for the other trials, but involved replacement of the pipette with a Geiger counter or a force probe to record decays or productions of force respectively.

Referring to FIG. 11B, increasing length of the antenna wire in the H⁺ medium proved useful in demonstrating the potential of the waves with spin-2 process in creating larger elements from the proton in that the line at ≈5.4 MeV, evidence that can only mean fusion occurred, represents the formation of helium. In other words, increasing the length of the wire in the medium allowed for multiple protons to be irradiated by the 2 Hz so that simultaneous decays in close proximity allowed for sharing of energies to allow for fusion, the success being observed with the 5.4 MeV peak and the 1.99 MeV peak for deuterium formation.

Although the 0.511 MeV peak in FIG. 11B is in the noise region, the line is nonetheless useful. In other words, the peak is nearly four times larger than the ≈1.026 MeV electron-positron peak, while the 0.511 MeV line in other graphs from the detector had only approximately twice the counts than the corresponding electron-positron peak. The increased peal could simply indicate additional positrons being produced, but all positrons can be thought to annihilate with a negative body. Yet, the reason for the increased peak is curious when considering lack of electrons.

The presence of the antiparticle of ³He having negative antiprotons provides the answer. Because a positron passing through matter can be considered equivalent to a hydrogen ion, the position and an anti-proton likely interacted and annihilated especially since the anti-helium was unstable: e^{→}+\overline{p}→annihilation, which produced the FIG. 11B ≈1.21 MeV peak. The annihilation of antimatter is extremely energy releasing, more productive than fusion, and the process demonstrated potentially how the antiparticle of one body can react with the antimatter of a different particle. This idea has never before been observed.

With the elimination of one antiproton, the other antiparticles of the anti-helium would have been more unstable to the extent that they can be thought to have been more exposed to the medium. Due to the free protons in the Pyrex tube, a proton-antiproton annihilation occurred next, resulting in four residual nuclei measured in FIG. 11B at ≈1.13 MeV, ≈1.15 MeV, ≈1.18 MeV, and ≈1.183 MeV due to possible scattering near 1.3 MeV. The remaining unstable antineutron also interacted with a proton evidenced by the ≈1.08 MeV line and resulting in pions, \overline{n}+p→3π⁺+2π⁻ which liberated great energy that was carried away by neutral pions. Two unstable π⁺ and antiparticles π⁻ interacted next, liberating further energy and leaving one π⁺ that quickly reduced to a positive muon and a neutrino that may have been an antineutrino. This action allowed the electron neutrino of a proton decay to collide and annihilate.

Thus, the above examples of anti-particle-particle annihilations demonstrate that the machine of FIG. 8 is immensely energy productive, particularly considering that depending on the number of bodies decaying the annihilations could be greater in number, thereby releasing more energy.

⁴He likely was created in the tube because of the abundant supply of protons and the instability of helium-3. Yet, the limited energy range of the detector prevented observation of outputs above 7.8 MeV. Though an original helium-4 would be a stable body just as a proton, considering the 2 Hz waves to have been continuous it is logical that a ⁴He became unstable and combined with a neighboring helium-4, similarly unstable due to the 2 Hz, to regain stability.

The creation of a helium-4 can be thought to have occurred shortly after the average time ≈360 s for the production of fusion or a wave with spin-2. One ⁴He reaching a point of instability while other heliums were being created is acceptable so that when the first helium-4 needed additional heliums for stability they would have existed. Thus, the waves with spin-2 process have been found to be a method for higher element production. By that, it was found that an excited helium combining with a neighboring ⁴He started the two-step process that created the extremely short-lived beryllium-8 that would have immediately combined with an additional ⁴He resulting in an unstable ¹²C. carbon-12 comprises near ninety-nine percent of all carbon on Earth and without it humans would not have evolved especially considering that ninety-seven percent of the human body is hydrogen, oxygen, and carbon. Thus, the machine of FIG. 8 may be used to produce tissue in that from the fusing of protons, greater bodies can be produced until actual cells and tissues emerge.

The process of decay involving 2 Hz waves does not change with larger elements in that the body most difficult and needed to be broken down is the proton, which causes a loss of stability that is regained by combining with additional elements. Exposing the ¹²C to 2 Hz waves and existing with additional ⁴He allows for larger elements, in that unstable ¹²C combining with a helium-4 produces oxygen-16. The process could continue until no more protons existed in the Pyrex tube. However, if an unlimited supply of protons could be provided, the fusion reactions would continue to the most stable fusion element iron-56.

If ⁴He were not available when a ¹²C had become unstable, a proton would be used for regaining stability in that the CNO cycle process common in larger suns could potentially begin so that the additional proton would cause the carbon-12 to progressively recycle slowly, with the energy output being enormous. Thus, the machine of FIG. 8 allows for the room temperature replication of the typical energy production chains in stars as the CNO cycle which is a recycling process that uses the carbon it produces to produce energy continuously.

Note, the interaction of the 2 Hz and the aligned H⁺ eliminates the need of high temperature for a proton-proton chain reaction, which requires high temperature for fusion. The 5.4 MeV peak in FIG. 11B provides evidence of the creation of ³He, the production and consumption of which fuels the Sun.

The potential of the waves with the spin-2 process in producing energy is described below with anti-gravity produced prior to the production of the gravity wave (wave with spin-2).

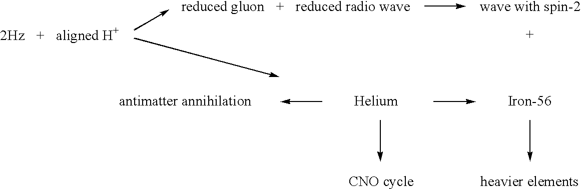

The potential of the waves with the spin-2 process is greater than originally expected in that not only did the FIG. 8 machine create the first observed production of gravity, but the FIG. 8 method of production can result in numerous manifestations of energy production including the creation of heavy elements. By that, the process of producing elements through fusion potentially is not limited to iron-56. Structures above ⁵⁶Fe are difficult to create because the elements can absorb great amounts of energy since larger nuclei contain greater strong force due to the increased number of nucleons. Thus, greater amounts of energy for fusion are needed. Scientists have suspected that heavier elements could have only been produced with the enormous energy released from supernovae explosions.

The machine of FIG. 8 can produce the same effect in that the repeated introduction of the 2 Hz signal, plus the magnetic field and the influence of energies including gravity waves produced in the machine significantly influences extremely stable nuclei to decay sufficiently for fusion with helium, protons, neutrons, or other elements depending on availability. Thus, the process created by the FIG. 8 machine constitutes a method to overcome typical restrictions in element production. Gravity waves created in the medium while fusion processes are occurring assists the progression in that the force helps to hold bodies together so that fusion can take place. Such assistance would be most helpful for unstable elements, and the help is identical to gravitational confinement for fusion in stars in that incorporating the method of the machine of FIG. 8 in present power generating plants can prevent energy loss through dissipation. This is similar to the processes in stars in that the energy produced by the subject system is be confined in the reaction vessel due to gravity, allowing for present plants to be ever more productive through the applications shown in FIGS. 3 and 4.

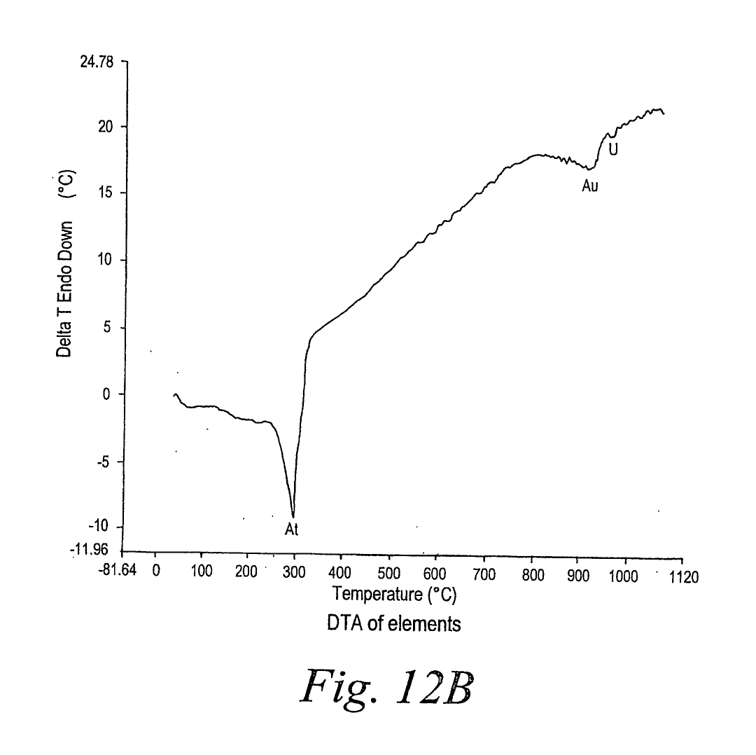

Turning now to FIG. 12A, the purpose of this experiment is to observe if large elements could be decayed with the waves with spin-2 process of the machine of FIG. 8. An experiment was conducted to decay the element tungsten, the element with the highest binding energies. In other words, success in decaying the tungsten nucleus would confirm the endless possibilities mentioned above. Because tungsten does not react with H₂SO₄ at room temperature, does not interact with copper, and is paramagnetic in that it aligns in a magnetic field, approximately 2 mg of the element was incorporated in the machine of FIG. 8. The volume of sulfuric acid was increased to 4 mL for trials to increase the amount of protons in the Pyrex tube for greater possibilities.

The FIG. 8 configuration was used. In this regard, container 120 was placed between magnet poles 122 and 124, while the copper wire 129 was inserted to direct electrons to the pelleted copper sink 128. The function generator 126 produced the 2 Hz that was directed to the medium by the antenna 132. Tungsten powder 220 was swirled in the proton volume, with slight excess powder 222 resting at the bottom of the Pyrex tube. Antenna 132 was inserted the complete length of the tube so that all in-line nuclei including the resting tungsten at the bottom of the tube could decay.

Numerous trials were run for longer periods, five to six hours, since more time was considered needed to allow for tungsten decay. The remaining volumes after the experiments were pooled 224 to make sure the concentration of any fused elements would be high enough to be observed with a Differential Thermal Analysis (DTA) machine 226 on which a 7.8 mg sample of the volume was run. The DTA machine was ideal in that it outputs melting points 228 of elements from a volume so that more than one element can be detected.

FIG. 12B shows peaks representing the elements, each having a higher proton number than tungsten. In other words, only through fusion could At, Au, and U have been produced. This view is confirmed since the issue of a contaminated tungsten sample is eliminated because astatine (At) is unavailable in nature and can only be produced in a nuclear reactor. Additionally, astatine has a short half-life, which means that the sample needed to be produced and then run on the DTA machine within eight hours to observe a peak. The run for FIG. 12B was less than two hours after the final experiment and pooling. Note, the final use of the machine incorporating a portion of the pooled volume involved a run for an additional five to six hours.

The machine was well-calibrated apart from above 900° C. Nonetheless, a control of pure gold was run. The Au peak appeared and had the same structure at the approximate location of the Au peak from the FIG. 12A experiments, allowing for identification and confirmation of the other peaks relative to the Au peak. Thus, using the machine of FIG. 8, it was demonstrated that room temperature decay of extremely stable elements can be achieved. This means that the constraints of the strong force are eliminated. By that, for the produced energies the strong force had to be reduced (decayed). This reduction allows for the unification of the forces of Nature and to the generation of gravity, anti-gravity, and particle-anti-particle annihilation. This creation is apart from simple decay leading to instability that allowed for fusion and also anti-particle-particle annihilation. Thus, as observed with the tungsten fusion trials, no sun in the Universe can achieve the success that was realized with the room temperature machine of FIG. 8.

### Explanation of the Phenomenon

The following summary is useful in understanding the subject invention. What will be appreciated is that a gravity wave is a traveling body of electromagnetic radiation. In other words, electromagnetic radiation is energy described quantumly with the equation E=hf, which is the Planck's constant (h) times the frequency (f) of the radiation. An additional quantum definition for energy is E=mc² so that E=hf=mc². The equation indicates that the energy of electromagnetic radiation is equivalent to a mass value. In other words, energy and mass are the same manifestation.

When nonionization energy enters a body, all components of the body become unstable in that they are given more energy than the body can support. Thus, they begin to vibrate (explained by the Planck's constant) in accordance to the frequency of the energy, i.e. E=hf. The vibration is a process of releasing the energy so that the bodies are not destroyed. The higher the frequency, the less maintained the effect the energy will have on the body. By that, less energy will be absorbed from higher frequencies since the vibration will be extremely quickly releasing the energy so that the effect on the body is essentially nonexistent. So if one looks at the electromagnetic spectrum, the energy from the portions of the spectrum that create vibrations essentially do not cause the bodies to be significantly affected since the additional energy to the bodies is lost quickly. This idea assumes that one wave at a time impinges on a body, with multiple waves causing an effect especially at a close distance considering 1/d² drop off of the amplitude of the wave.

A gravity wave is electromagnetic radiation with energy equal to 1.678×10⁻³⁵ J, which means that if a gravity wave were included in the electromagnetic spectrum it would be placed on the extreme left before AM radio. Thus, gravity waves have the lowest possible frequency due to creation of the body from the decay of a proton and the decay of radio waves. Therefore a reduced gluon combines with a reduced radio wave to yield anti-gravity and a gravity wave.

As described above, when energy passes through a body the components vibrate. The lower frequency will cause a slower vibration in that the energy is not lost quickly. The energy will stay in the body longer causing components to fall apart eventually, i.e., die. As time progresses and more gravity waves pass through a body, more of the components of the body will vibrate and lose structure or mutate, causing the body to fall apart and die. In a medical application gravity waves can cause premature death in that if they are focused on a diseased structure, they can lead to accelerated decay of the body through vibration. Thus, tumors and faulty components as DNA causing diseases as AIDS can be attacked.

When a gravity wave passes though a body, since it has a low frequency the gravity wave is kept in the body longer since the components of the body cannot get rid of it fast enough. When bodies have excess energy they vibrate, which is an attempt to release the excess energy as discussed above. When bodies are vibrating close together, the energy being released with the vibrations come in contact with the other bodies. Thus, a sharing of energy begins in that the more energy entering bodies from repeated gravity waves, the more energy will be shared so that the bodies eventually become more as one. Ultimately, the bodies are no longer separate since they share so much in that they are one body in a so-called fusion process.

The process of fusion can be performed for any element, since fusion was achieved using tungsten. The fusion of tungsten was no different in that protons were added to the nucleus gradually until larger elements resulted; Though At, Au, and U are presented as part of the experiment that produced FIG. 12B, other elements were created including fusion of two tungsten atoms. Use of a periodic table including neutron number is most useful in understanding the process. For example, to produce the next element on the periodic table, i.e., rhenium above tungsten, two protons need to fuse to the tungsten nucleus. This process is possible because of the subject proton decay, and the additional proton in the fusion decays to a neutron to allow the body to be stable.

Production of Osmium is more extreme in that five protons would have had to fuse to a tungsten atom. This process requires four protons to decay to neutrons to allow for stability of the Osmium atom, as observed in the 114 neutron number of the atom compared to the 110 neutrons of tungsten. As seen in FIG. 12B, the process of adding protons to the tungsten nucleus continued to the extreme of uranium in that fifty-four protons were added to a tungsten nucleus. Thus, eighteen of the atoms were maintained protons while the additional thirty-six protons decayed to neutrons, positive beta decay and through the influence of the 2 Hz radio wave. More than one element existed in the sample run on a DTA machine used in the experiment since the number of tungsten atoms and protons in the Pyrex tube were high so that sufficient protons could add to tungsten atoms individually differently depending on the proximity of the decaying protons to the decaying tungsten atoms. Also, pooling the results from the trials increased the possibility of multiple elements in a sample since different elements were produced in various trials. The tungsten atoms fused though the melting point was far beyond the capabilities of the DTA machine, operation of which was limited to 1200° C. The production of an atom of two fused tungsten atoms (¹⁴⁸atom) would not be dissimilar in that the fusion method is consistent with the decay of bodies close together causing sharing of energy to eliminate free energy to allow for stability.

Naturally, for every particle an anti-particle would be made so that the fused tungsten atom would have a corresponding anti-particle. The elements of FIG. 12B thus were created with anti-particles in that the anti-particles could be observed more obviously by creating fusion for only one tungsten atom with protons, so that any additional weight in the medium would be considered due to an anti-particle. Thus, the subject technique described in FIG. 8 can be considered to be an element and anti-element generation machine.

The energy that enters from one gravity wave is small, but as more waves enter more energy is gained by the individual components. The more shared energy causes the components to become one since they are sharing so much of the same thing, i.e. from one component a larger component is formed. The concept of energy being mass is the same. More energy in one component causes the body to become larger. As the component becomes larger, it becomes a greater body of matter since it occupies more space. So, occupying more space can be thought as being due to a larger body, which is larger because it has more energy. In other words, greater energy leads to greater matter that is the same as a greater mass or body in space. Thus, the more energy a body obtains, the greater it increases in mass, i.e., the more space it occupies and the more bending of space resulting.

A gravity wave is generated in the subject process by decaying a proton held aligned in a magnetic field with 2 Hz electromagnetic energy. The aligned proton being in the low energy state for the body when having the 2 Hz radio waves passing through it decays because it cannot typically move, since it is held in place by the magnetic field of sufficient strength. Thus, rather than vibrating to release sufficient energy, the proton falls apart gradually and quickly, within 360 s, due to the excess energy. The Higgs field is the fundamental component that allows for the strong force that holds the proton together. Since the proton decays, the Higgs field is exposed. Thus, the reduced gluon can be accepted as equivalent to the Higgs field in that the proton when in the Higgs field state combines with the final radio wave that barely is affected by the remaining proton in the magnetic field. The combined reduced gluon and reduced radio wave is the gravity wave.

The gravity wave travels from the point of union. It is an electromagnetic wave in that it loses energy as explained by the inverse square law (1/d²). When the wave reaches the water drop in the above experiment, the gravity wave energy of a low frequency affects the drop so that the components of the body or the drop itself can be imagined to vibrate. The excess energy increases the mass of the body so that it falls to the Earth as explained by the Newtonian equation GmM/d². An understanding of space-time is not necessarily required to envision the notion that bodies with larger mass fall to Earth more quickly or with greater force as explained with F=GmM/d². However, the falling as with any attraction to the Earth can be explained since the Earth too bends space so that the Earth can be imagined to be sharing its energy with all bodies inhabiting the planet and attracted to it. The drop returned to its previous position after the gravity wave encountered it because the energy was not sufficient to maintain the fall. In other words, the low amount of energy was lost in the little vibration of the drop so that its returning is an indication of release of the additional energy.

The British Physicist Higgs predicted an additional body that gave mass to the elementary particles at the beginning of the Universe. The Higgs field (reduced gluon) and the reduced radio wave combine at a specific point. At that point, a final release of energy occurs in that the components of the field are released. The components released are the Higgs boson and the anti-Higgs boson.

The bosons when in the field have spin-0 meaning that they are completely symmetrical. However, after the merge of the reduced bodies the bosons become spin-2, a state making them unstable causing them to release energies from the point of union. If the Higgs boson is spin-2, the anti-Higgs boson has to have the opposite character of spin-2. The state of the anti-Higgs boson is the same state of anti-gravity in that gravity is spin-2 and anti-gravity predicted to have been released at the point of union is spin-2. Thus, the anti-Higgs boson is responsible for the force anti-gravity that provides the opposite effect of gravity.

The effect of anti-gravity is from the point of union in that it does not have 1/d² character, exactly as the anti-Higgs boson. Therefore, the anti-Higgs boson is considered the exchange particle for the force anti-gravity. The exchange particle is the Physics term that means that it is the reason for the force just as a wave with spin-2 is the exchange particle for the force gravity. The exchange particle is used synonymously to its force in discussions. After the reduced bodies merge, the presence of the Higgs bodies is proved by the experimental fact that the water drop moves up a distance before, moving back to the previous position. This action means that the body has a reduction of mass due to the influence imparted from the point of union due to the force anti-gravity prior to returning to the prior position where the gravity wave interacts with it to give it an increase of mass causing it to fall to Earth.

The proton decaying reaches the most extreme point of existence, that being the reduced gluon. The Higgs field gives mass to all bodies including the Higgs boson that exists in it. The dark spot of the reduced gluon of FIG. 9B is the boson. In other words, any body traveling through the field, can be thought as a cloud of energy just as gravity is a wave of energy, receives the energy manifesting itself as mass due to the imparting of the energy on the body.

The union of the reduced bodies is actually a release of the Higgs field, observed to have existed since the Higgs boson and anti-Higgs boson were verified with the anti-gravity observations. Yet, the Higgs field is more in that it maintains order. In other words, the union of the forces of Nature was due to destruction of symmetry, i.e. the proton and the radio wave lose symmetry with the extreme of the proton being essentially destroyed. The remaining Higgs field can be thought as the final attempt of the proton to stay alive. The existence of the field shows that symmetry was destroyed in that the energy cloud can be thought as a reaching out to cling to something so that the proton can exist in some way. Thus, the unified Force equivalent is the visualization of this attempt so that the proton is eventually successful in staying alive but through the new symmetry of the gravity wave being spin-2.

The anti-Higgs boson influence is seen with anti-gravity, and the Higgs boson existence as the reason for the creation of elementary particles with mass. Additionally, the bosons can be thought the reason for charges since the anti-Higgs range was calculated to be 10⁻¹⁹ C. In other words, the subject technology may be used to generate new charges or forms of charges so that bodies can have varied electro character. The steps below summarize the above described progression.

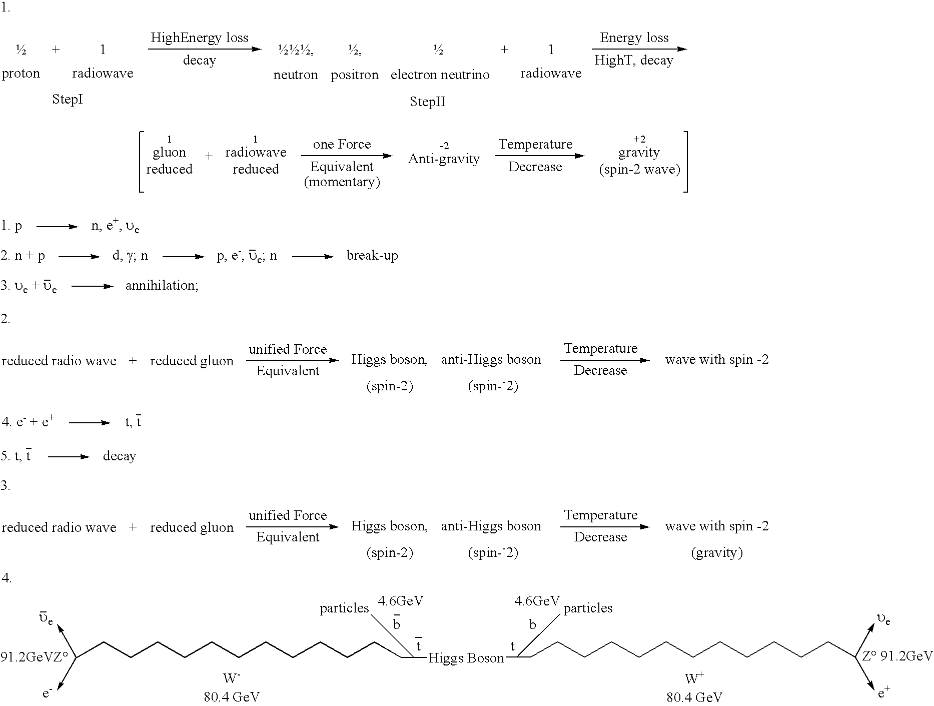

Water drop trials showed that one can generate a gravity wave at room temperature and direct it to a specific point in that a water drop has been shown to increase in mass due to the wave with spin-2 energy passing through it. Thus, a specific energy value is associated with each wave with spin-2 so that if one increases the number of waves with spin-2 one increases the energy that would increase mass (mass-energy). Anti-gravity influences would also increase but not with the same gravity wave character or energy. Thus, when the two magnets are equally distanced from a water drop, remembering that the energy of a gravity wave is lost as it travels as explained by the inverse square law, the two magnets influence the water drop twice as much as one magnet alone from the same distance to the drop. Thus, 2 waves lead to twice as much mass-energy or E=2 mc². Accordingly, with three magnets the mass-energy would increase by three: E=3 mc². It has been found that the more waves the greater energy input, resulting in greater mass of the body. As seen in FIG. 10, it has been found experimentally that gravity waves travel, that the waves can be directed, that the gravity wave can be attenuated or modulated as are wireless communication waves, and that output can be increased at specific points. Thus, massive points of mass can be made simply by directing multiple waves.

A black hole can be thought of as a massive point whereby space is so significantly bent or warped that nothing can escape from it. The example is similar to a sailor being trapped in a whirlpool, and he or she is trying to swim out but cannot. Thus, the subject technology can be used in one form to create synthetic black holes at any location. For example, a synthetic black hole could be produced over a city whereby all components in the city would be influenced by the output radiation or energy from the point causing a simultaneous sharing of energy for all bodies in the range of the energy so that attraction to the massive hole would occur.

Directing gravity waves from satellites could be useful in that gravity waves could be directed to points globally to provide energy. The use could be to eliminate hurricanes and tornadoes, to create rain by directing waves to clouds, to clean bodies of water as to allow the water to be safe for drinking by causing parasites in bodies of water to die by being under increased pressure due to the addition of mass, etc. The production of rain has been already achieved in the laboratory in that the trials of FIGS. 8 and 10 demonstrate that water drops could fall to Earth if irradiated with gravity waves.

Further, as to satellite use, the 2 Hz used to generate gravity waves with spin-2 could potentially be obtained from solar flares bouncing off the Earth or other magnetic field bodies. In fact, a satellite could be designed so that a solar flare interacting with it would produce the 2 Hz. Thus, gravity waves could be generated in the same process of decaying protons with a sulfuric acid process that would be performed in the satellites.

It has been found that anti-gravity does not travel like gravity and its imparting influence from a specific position would explain its limited range. Drop movements upward were seen in experiments described in FIG. 10 because the number of points of union were doubled, which resulted in an approximate doubling of the anti-gravity influence on drops. Thus, the effect of the repelling force can be acknowledged to rise as the number of anti-gravity points directed toward a body increases.

The drop movements in FIG. 10 trials versus control one magnet trials, maintaining distance measures for the set-up, led to the observation of the connection of numbers of waves with spin-2 and acceleration in that a relationship between the number of waves and the distances of the drop falls was understood:

$$\frac{{g}^{2}}{2} \sim d .$$

Since anti-gravity was explained not to have the same character as gravity, the correlation does not exist for the repelling force. Because Galileo established d˜t² a connection between waves with spin-2 and time was visualized in that

$$\frac{{g}^{2}}{2} \sim d \sim {t}^{2} -> \frac{{g}^{2}}{2} \sim {t}^{2} -> t \sim \sqrt{\frac{{g}^{2}}{2}} .$$

In other words, total distance covered is proportional to the number of waves with spin-2 in, passing through, an object squared and divided by 2. Units of time can be thought created as waves with spin-2 pass through a body so that the more waves with spin-2, the greater time the body possesses. An object subjected to a constant number of waves with spin-2 (gravity) will therefore be influenced consistently by the equivalent time. In other words, total time resulting with the curved space is proportional to the square root of the number of waves with spin-2 squared and divided by 2. Thus, t=\sqrt{space} originally presented in hypothesis work that led to experimentation is confirmed when distance is equated to space or position. The increasing of time in relation to addition of gravity waves is further described by the table below.

Relations to Waves with Spin-2

| g | (g\hat{ }2)/2 | d | t\hat{ }2 | t |
|---|---|---|---|---|
| 1 | 0.5 | 0.5 | 0.5 | 0.70710678 |
| 2 | 2 | 2 | 2 | 1.41421356 |
| 3 | 4.5 | 4.5 | 4.5 | 2.12132034 |
| 4 | 8 | 8 | 8 | 2.82842712 |
| 5 | 12.5 | 12.5 | 12.5 | 3.53553391 |
| 6 | 18 | 18 | 18 | 4.24264069 |
| 7 | 24.5 | 24.5 | 24.5 | 4.94974747 |
| 8 | 32 | 32 | 32 | 5.65685425 |
| 9 | 40.5 | 40.5 | 40.5 | 6.36396103 |
| 10 | 50 | 50 | 50 | 7.07106781 |
| 11 | 60.5 | 60.5 | 60.5 | 7.77817459 |
| 12 | 72 | 72 | 72 | 8.48528137 |
| 13 | 84.5 | 84.5 | 84.5 | 9.19238816 |
| 14 | 98 | 98 | 98 | 9.89949494 |
| 15 | 112.5 | 112.5 | 112.5 | 10.6066017 |
| 16 | 128 | 128 | 128 | 11.3137085 |
| 17 | 144.5 | 144.5 | 144.5 | 12.0208153 |
| 18 | 162 | 162 | 162 | 12.7279221 |
| 19 | 180.5 | 180.5 | 180.5 | 13.4350288 |
| 20 | 200 | 200 | 200 | 14.1421356 |

The time increases above are possible since the notion that gravity waves are energy does not change. The table shows the increases in time with increased gravity wave number. Thus, if one increases the number of gravity waves on a body, one is still increasing the amount of energy on the body in that mass increases accordingly. The table below expresses the notion considering the amount of interactions suspected that a proton must have with radio waves before decaying to the reduced gluon, considering that the radio wave loses energy also before interacting with a proton at the furthest possible distance in the Pyrex tube.

Interactions possible/m Typical distance from Hz wire to Pyrex
wall Interactions Total g-waves Total energy from all g-waves in
a process (J)

| | | | | |
|---|---|---|---|---|
| 4.741311 E+33 | 0.005 | 2.4 E+31 | 1 | 1.77637 E−06 − 1.77637 E−08 |
| 4.741311 E+33 | 0.005 | 2.4 E+31 | 2 | 3.55275 E−06 − 3.55275 E−08 |
| 4,741311 E+33 | 0.005 | 2.4 E+31 | 3 | 5.32912 E−06 − 5.32912 E−08 |
| 4.741311 E+33 | 0.005 | 2.4 E+31 | 4 | 7.1055 E−06 − 7.1055 E−08 |
| 4.741311 E+33 | 0.005 | 2.4 E+31 | 5 | 8.88187 E−06 − 8.88187 E−08 |
| 4.741311 E+33 | 0.005 | 2.4 E+31 | 6 | 1.06582 E−05 − 1.06582 E−07 |
| 4.741311 E+33 | 0.005 | 2.4 E+31 | 7 | 1.24346 E−05 − 1.24346 E−07 |
| 4.741311 E+33 | 0.005 | 2.4 E+31 | 8 | 1.4211 E−05 − 1.4211 E−07 |
| 4.741311 E+33 | 0.005 | 2.4 E+31 | 9 | 1.59874 E−05 − 1.59874 E−07 |
| 4.741311 E+33 | 0.005 | 2.4 E+31 | 10 | 1.77637 E−05 − 1.77637 E−07 |
| 4.741311 E+33 | 0.005 | 2.4 E+31 | 11 | 1.95401 E−05 − 1.95401 E−07 |
| 4.741311 E+33 | 0.005 | 2.4 E+31 | 12 | 2.13165 E−05 − 2.13165 E−07 |
| 4.741311 E+33 | 0.005 | 2.4 E+31 | 13 | 2.30929 E−05 − 2.30929 E−07 |

Experiments described in FIG. 10 relating to time can be better comprehended by reviewing historical progressions. According to Einstein, what is observed as gravity, a drop falling, is equivalent to acceleration. The distances to which drops fell were in accordance to the number of waves with spin-2 directed on the drop. By that, observed gravity or acceleration increased as gravity waves increased. Thus, reviewing the data a pattern emerged in that the exact distance of fall could be compared to the number of waves directed on the body in that distance could be predicted similarly to Galileo's work of acceleration affecting a rolling ball. In other words, he observed acceleration by rolling a ball and created the equivalence d˜t². His observation was no different apart from the apparatuses of FIGS. 8 and 10 creating the acceleration (gravity). By that, a drop fall distance was equivalent to gravity or acceleration in accord to the amount of gravity waves on the body, found from comparison of one magnet and two magnet trials, so that a proportionality with time is written

$$t \sim \sqrt{\frac{{g}^{2}}{2}}$$

with g representing number of gravity waves.

By increasing the number of waves with spin-2 on a body, the body has an equivalent time increase defined by

$$t \sim \sqrt{\frac{{g}^{2}}{2}} .$$

Definition of time is not changing in that an age can be thought equivalent to a time. A body in space thus receiving a consistent number of waves with spin-2 can be characterized by a consistent time. The notion of the imparting of time by gravity waves does not change the idea of the effect of gravity waves in that the relation between gravity and time can be better understood with the idea that increases in time are due to providing a body with greater internal movement, vibration, or energy. For example, if a glacier were subjected to waves with spin-2, movement of the body would increase so that the block of ice would melt completely sooner.

Since time is most commonly perceived as progression from one day to the next, the concept may be better understood with an Earth example. For example, if the amount of waves with spin-2 passing through the Earth were sufficiently multiplied, unlikely ever achievable though the Sun is growing, the increased energy could influence overall movement of the planet in that rotation would increase or become faster, inadvertently providing centrifugal influence to counter the additional gravity that can be achieved synthetically with the subject technology. Thus, the length of a day would be shortened creating a greater passing or addition of time.

The connection can be furthered in relation to mass and senescence explaining potentially how tissues age naturally including apoptosis (programmed cell death) that may be triggered in various cells after receiving certain numbers of waves with spin-2, creating greater thought regarding using spin-2 waves to fight diseases. By that, subjecting a cell to increased amounts of spin-2 waves might cause the time of the body to increase so that decay or senescence would be created, which could be most useful in eliminating diseased cells before potential spreading. The concept also could be used to examine premature aging as Progeria with the notion that waves with spin-2 can trigger genes. The idea suggests also that excess genes may exist in the human body that may not be beneficial, being masked by other genes that evolved possibly simply to prevent activity of the improper genes that could be triggered to function by sufficient numbers of waves with spin-2. Thus, subjecting genes to anti-gravity may be a method of countering the effects of waves.

Continuing the notion of increasing time, if subjecting a point to a great deal of waves of spin-2 the time at that point would be greater than surroundings. In other words, time at that point would be advanced comparatively so that if standing at the point surrounding events would appear moving slower since the point is at an advanced time. Thus, the technology makes time travel possible.

A simpler way to think of the notion can be in further relation to electromagnetic energy. By that, classically the advancement of time has been thought constrained to the limitation of the speed of light in that to move forward in time the barrier would have to be overcome. Therefore, radiating with gravity waves allows for the overcoming of the restriction that could be explained since to form a wave with spin-2, two bodies defined with the speed of light merged causing a gravity wave to be described by c². In other words, subjecting a point to a gravity wave causes the point to be under the influence of an advanced speed of light so that gravity wave radiation can provide time to irradiated bodies as defined by

$$t \sim \sqrt{\frac{{g}^{2}}{2}} .$$

The character is maintained when manipulating waves as in quantum computing in that resulting packets of energy have the same character. So when packets of energy interact, the quantum system packets influencing each other with the characteristic energy create a connected system not constrained to the speed of light. The notion allows for the understanding of creation of networks functioning significantly faster than present technology can allow.

Reiterating, directing gravity waves to a point is equivalent to transferring the characteristics of the wave to the point. The point is under an external periodic force. Therefore, it would emit radiation with the same frequency as the external stimulus wave with spin-2, which is an explanation for how a body can give-off spin-2 waves. The emitted radiation frequency equals the frequency of the external force because the force on the point from produced spin-2 waves is discrete, instantaneous, discontinuous, and periodic.

What was described is the case at black holes in that the center can be thought to be such an advanced point of time that light does not travel fast enough to escape, consideration of gravity as a time definition. However, arriving at a point as the center of a black hole is difficult as previously described particularly due to the gravity radiation of the point. Success in reaching the point could be achieved if traveling in a body that received the gravity influence from the black hole equally simultaneously. But the traveling body would have to be devoid of multi-dimensions. Or if the traveling body continuously exerted anti-gravity as at points receiving the gravity influence later, the potentially destructive gravity force could be countered allowing for arrival at the point of increased time.

As mentioned, the time of diseased cells could be increased to destroy the harmful bodies. Also, time is a dimension. If increasing waves with spin-2 on a point, dimensionality of the point would be increased, not necessarily simply related to increasing time but generally. In other words, the gravity of the point could warp surrounding space greatly influencing and increasing dimensionality. Also, the notion of dimension creation is further expanded if considering that a universe is simply a dimension or on a dimension as described in some works. Thus, the technology could essentially create additional universes.

A slowing or reversal of time can also be achieved when remembering that anti-gravity has the opposite effect to gravity. In other words, the repelling force could cause a body to be less under the influence of time. But supply of the anti-gravity influence would have to be without the gravity influence. The idea is possible since anti-gravity was observed to occur sufficiently prior to a gravity wave so that a body could be pulled out of the way once the anti-gravity influence is provided before the gravity wave emerged. The idea is related to the concept that both anti-gravity and gravity seemed to influence in the same direction. Thus, anti-gravity could also be used for functionality because of the continuous notion of an opposite effect to the attractive force gravity.

The primary reason for experiments with FIG. 10 was to observe if multiple gravity waves could be directed to the same point thereby increasing the amount of energy on the point. The success with FIG. 10 showed that effect was doubled at the point since two waves were directed. The increase of effect thereby can be thought to correspond to the number of waves with spin-2 in that directing three waves would cause a tripling effect, i.e. effect increases according to the number of waves with spin-2 used as long as they are from the same distance away. If one directs more than one wave with spin-2 to a location but at different distances, the effect is not consistent in that one has to consider the separate distances from the point. Thus, the set-ups in FIG. 10 were equally distanced from the water drops of the pipette.

The experiments described in FIG. 10 showed that gravity waves travel, are explainable with 1/d², and can be directed. Thus, the notion of modulation as for wireless communications is possible, and the energy from the waves can be increased at will easily and inexpensively allowing for use potentially at locations large distances from the creation. In fact, schlieren photography was used that allowed observation of what was concluded could be traveling waves of gravity due primarily to the timing of the observations coinciding with times of drop falls. And the waves were observed to create multi-dimensional tori that were atypical compared to convection currents, though the creations could certainly have been convection currents of different forms.

Use of gravity waves for wireless communications would have enormous advantages in that gravity waves can carry more data for longer distances considering placement of the waves on the electromagnetic spectrum. Thus, larger bodies could potentially be carried in that the waves could be used for transportation. Considering that the waves can easily travel through objects, potentially carrying structures as biological bodies like RNA on the waves through a human body as in drug delivery is possible. By that, if irradiating the drug sufficiently to be carried so that when it is energetic enough, it could possibly join to a gravity wave, as did the reduced proton to a radio wave to initially produce the gravity wave. Thus, the wave would become a medicated wave that delivers treatment when passing though and imparting the medicated energy.

Use of gravity waves medically can have enormous potential particularly since hypothesis work prior to experimentation led to the notion that nervous systems became more advanced as they evolved into wave with spin-2 quantum computing systems. The notion was understood after success with the FIG. 8 experiment in that the same components for the process are understood at least in the human body, more specifically due to mitochondria that can be thought of as hubs being in every cell, so that the same manipulations as described for quantum computing are not far-fetched. Thus, use of waves with spin-2 through implantation or with external direction could return functionality to damaged or diseased areas in that the surrogate waves with spin-2 would replace faulty or severed networking.

For example, the nervous system is a networked process in that one neuron communicates with the next, hypothesized to involve the waves with spin-2 quantum process that would explain the rapidity of the system that has not yet been replicated synthetically since the waves with spin-2 process has never before been proposed. If damage existed whereby communications ceased, the waves with spin-2 process through an implant or external direction could be used to allow nerves to return to normal processes of communications. What is suggested is the use of quantum computing medically, and the application could potentially treat conditions as paralysis.

Additionally, synthetic systems could be created that would be artificial intelligence technology based on the notion that use and manipulation of gravity waves would overcome the speed of light barrier in that communications would be enormously improved. Thus, the notion of synthetic systems based on the human model even to the extent of artificial human systems that may even incorporate engineered tissue is plausible.

Such neural networking would have numerous applications as improving the networking of computers or interfaces generally similarly to LANs or WANs, improving Internet technologies, or using the technology for creation of new systems as by making novel fuzzy neural networks.

Also, the technology can improve or create new technologies related but not limited to software or expert systems generally, signal processing, image data processing, communication systems, or optimization techniques. Additional use of the technology could be for the development of circuitry, speech and face recognition, speech production and reproduction as from text including translation applications, navigation systems, radar-like systems, target recognition, writing recognition, automatic guidance systems, and real time processes. Further application may be found for weather forecasting, mechanical machines, stock market predictions, domestic appliances, fuel cell technologies, nanotechnologies, visual reality, merging technologies, cooking technologies even to the extent of creating gravity wave ovens, improved hardware as for computing including wearable computing generally or in specific applications as for satellites or robotics or more generally in handhelds, propulsion systems, scanning and imaging/identification technologies including for use in cameras or holography, and emergency systems.

The uses are numerous and can continue as related to FIG. 5 for creating systems that can alter the course of asteroids or other objects moving toward a location, as for molecular manufacturing creating new biological systems or hybrid electronic/biological technologies or creating molecular machines, creation of removable or non-removable interfaces between computers and cellular organisms particularly involving the brain that could allow for control of objects or machines by simple thought, control mechanisms for use as biological sensing devices that reside in organisms to monitor health or act on problems or for general functions when needed, creation or use of alternative fuel supplies, creation of new biological bodies as a new energy molecule as ATP so that the biological body can be used physiologically or in an alternative manner, development of fabrics or polymers that could potentially repair themselves using a wave with spin-2 process, production of any element of the periodic table from other elements and new elements entirely including new atoms and molecules (polymers), energy production incorporating foreign bodies as using the conductive Earth, or for waste disposal. Or the waves with spin-2 process could be used indirectly as to understand economic phenomena in that since creation is periodic with consideration to the Schrödinger equation, economic events may be better predicted using a similar manner to the gravity wave production scheme.

The room temperature for experimentation can be thought as a significant temperature decrease, similar to a freezing, compared to the high temperature at the beginning of the Universe. In other words, the room temperature allowed for step by step observations of the process of producing a wave with spin-2 (gravity wave). Thus, if more time is needed to take advantage of a step in the process as in using anti-gravity or causing the Higgs boson to exist for a longer period to benefit from the body releasing energy manifesting as mass, a further reduction of temperature may allow for such action.

Yet, work showed that reductions in temperature could possibly reduce the influence of anti-gravity. Thus, a more defined period of anti-gravity could exist but the influence could be less. Still, specific applications of energy from the machine of FIG. 8 could include treatment of diseases particularly related to mitochondria; manipulating biological-processes as replication, transcription, RNA editing, translation, or cell division using spin-2 waves; other work related to genomes; genetic engineering and cloning; tissue engineering; and use specifically in drug development as in creating chirality. More interest by the general public may involve use of the subject technology to break bonds in fat so that the method can be used for weight control, destroying pathogens while in a body, and life extension or the elimination of a process involved with senescence. Scientists may be more interested in using the waves with spin-2 to simulate PCR activity in a cell; altering a physiological course to allow for another technique to function properly normally, as altering DNA to allow for the incorporation or coming together of new DNA; anti-gravity for any reason including levitation; and altering atomic structure as for example squeezing more electrons or similar particles on orbitals or energy levels to create greater energy supplies, to increase the energies of molecules or atoms, or for any purpose particularly related to energy as was performed with FIG. 12A to add protons to nuclei.

The method using the machine of FIG. 8 could be used to create matter as in producing new forms of plasma or new matter entirely. The subject technology can be used in engine technology or for use in transportation generally. The subject technology can also be used to move objects due to the attractive or repelling force. Moreover, energy from the machine of FIG. 8 can be used to test the strengths of materials, the strengths of constructions such as bridges, or testing the structure of any body on any level including molecularly. Energy from the machine could make engines or machines more effective as by increasing the amount of steam similarly to use in power plants so that a steam engine can work more effectively. Finally, the machine of FIG. 8 can replace or be incorporated in a wide variety of engines, since the subject device produces an extreme amount of heat.

### Proton Decay and Unifying the Forces of Nature

Particularly, proton decay was achieved and led to a grand unification theory: What is explained herein is the decaying proton process incorporating the Higgs field that was photographed, allowing for a prediction of the mass of the Higgs boson. The course of unifying the forces as mentioned previously also demonstrated the existence of a fifth force of Nature named anti-gravity since it appeared with character contrary to produced gravity. The subject invention therefore involves the first expression of a unification of the forces of Nature in a laboratory.

The Higgs field has never been observed while mass for the mediating boson, thought to have provided mass to the fundamental particles, is sought experimentally globally As mentioned, the half-life for the proton predicted to be at least 10³⁵ years is accepted reason for the lack of success in observing decay of the body. Additionally, proton decay has been considered not possible since it could violate conservation of baryon number.

Decay of the proton revealed grand unification, referred to as one Force equivalent or unified Force equivalent since the union is compared to the one Force at the beginning of the Universe. The comparison is valid despite the fact that the subject process is done at a lower temperature and involves exposure of the Higgs field that was released with decay of the strong force, essentially equivalent to proton decay. The process of unification is shown not to violate conservation of baryon number and to lead to a new symmetry as a wave with spin-2, synonymous to the graviton, or gravity that never before was produced in the laboratory. In other words, confirmed production of gravity was evidence that unification was achieved.

Laws of Physics were not violated in that produced gravity is described as an attractive force that gives objects mass so that both Newtonian and Einstein descriptions are understood correct. Data presented how a quantum mechanical understanding for the attractive force coexists in that imparted waves with spin-2 energy explains mass increases that dictates bending of space and advancing of time while simultaneously increasing 1/d² influences between bodies. Yet, full historical discussion is not undertaken.

### Theory

An apparatus illustrated in FIG. 8 was constructed to test the hypothesis that if a proton were held aligned in a sufficiently strong magnetic field maintaining the low energy state, the body could be decayed with cyclic electromagnetic energy. The proton was never before decayed. Scientists at international laboratories/nuclear reactors as CERN study particle Physics by colliding particles to decompose them using their US$billion facilities. The machine of FIG. 8 was under US$100 though the inventor spent no more than US$20 in two years of research utilizing the device in experiments to test hypotheses.

The first version named G-QUANTA MODEL I machine can be viewed as an inexpensive nuclear reactor evidenced by the production of energy and elements as seen with the At peak in FIG. 12B. Difference in energy between high and low states for particles in the machine is proportional to strength of the magnetic field in that more energy is required to oppose a stronger field. Thus, construction of the device was achieved keeping in mind that a constant field maintaining. H⁺ alignment during interactions with electromagnetic waves of specific frequency could allow for gradual decay. The FIG. 8 machine is adaptable in that parts can be added for increased functionality. For example, centrifuge-like adaptations or use of the machine with objects that create similar effects to the centrifuge can be used to increase the effect of gravity waves through a Coriolis-like influence.

Approximately 2 Hz square and sine waves, amplitude (Vₚ₋ₚ) about 12-12.5V, were found to be the only frequency reliably causing proton decay, roughly 12.5V used predominantly. The amplitude range was considered due to the contained H⁺ medium so that it likely would be less or more respective to change. An oscillator circuit as presented above for square waves originally used for the FIG. 8 machine was replaced with a function generator to test easily other frequencies (0.1-70 Hz, 1.0 kHz, 10 kHz, 100 kHz, 1000 kHz) with varying amplitudes. Proton decay was confirmed incorporating simple methods as the acid/base indicator phenol red, with reddening during H₂SO₄ trials indicating reduction in H⁺ numbers, and instrumentation as a germanium detector, resulting in peaks representing decays.

### Spins and Interactions

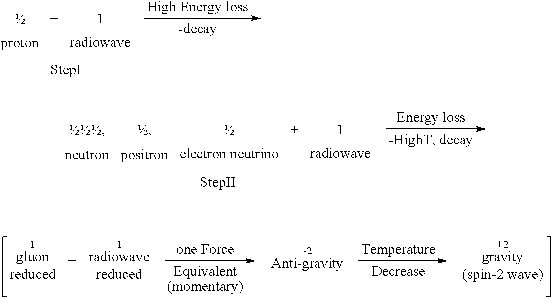

The above presents spins and interactions with 2 Hz waves. Conservation of baryon number is maintained, remembering protons and neutrons are of three quarks each having the baryon number ⅓. Note thus that the baryon total 1 for the proton in Step I equals the sum for the neutron due to decay. The many radio wave interactions and each result are not expressed individually above in that only the most important steps are shown beginning with the meeting of one proton and one radio wave. The brackets specify rapid, invariant grand unification. The word “reduced” describes the state of being unstable compared to preceding forms particularly for the gluon not typically separately perceived. Simply, the reduced gluon is an expression for the proton being in the extremist form of existence due to decay.

Step II is primarily the interaction of the neutron and a radio wave so that decaying and stability loss is understood as the process progresses. The quarks of the neutron (½ ½ ½) become evermore loosely-held due to continued radio waves. However, overall energy loss is not as high as in Step I that involved more radio wave interactions, exposing the mediating X-boson that allowed for Step II.

Immobility of the gradually falling apart proton due to the magnetic field was reason primarily for deterioration of the interacting bodies, interaction of electromagnetic radiation and matter, since the proton could not move typically. The final radio wave before formation of gravity thus is relatively barely affected since the proton is in an extreme state of reduction barely affecting the radio wave. Therefore, the wave nature of the new body with spin-2, the gluon and radio wave having maintained spins, is due primarily to the less reduced wave. Higher temperature, relative to at the beginning of the experiment, at the first bracket indicates the reduced structures are in highly excited states. Thus, to achieve stability they merge creating the one Force equivalent.

As to the gravity wave with spin-2, creation of gravity was observed with the FIG. 8 Pasteur pipette, which held water drops in-line with the Hz wire (antenna) in the Pyrex tube. With the 2 Hz signal on, due to the gravity wave imparting energy the drops fell 1-3 mm being attracted to Earth. This movement occurred approximately on average every 360 seconds, corresponding to the decay of protons. To ensure encounter with a wave with spin-2, multiple drops were created and marked in position on the pipette.

When not directly against the tube, the pipette was influenced by gravity in that it at times was attracted, when not held too firmly in the clamp, momentarily prior to drop falls. Attraction seemed to adhere to the inverse square law, observed in trials with the pipette varying in distance from the Pyrex tube. Also, pipette movement was not the reason for drop movements since drops fell even when the pipette was secured in place as being held against the tube.

Observation of the additional force anti-gravity was not expected and began to be considered when observing drop movements upward, initially seemingly equivalent in distance to drop falls, to be consistent as with accompaniment by temperature decreases at coinciding times. The temperature changes were observed with a large dial thermometer placed in the tube. Note that the temperature decreases were prior to drop falls, and occasionally the pipette was pushed away. The drop falls did not occur immediately after the temperature decreases. Rather, brief delays were typical suggesting required formation, travel, and imparting of the gravity energy on the drops.

The repelling influence was thought to be operative from where a proton had decayed since the effect did not follow the inverse square law as with upward drop movements not always seen. In other words, reference points on the 2000 Gauss magnet allowed proper aligning of drops in the pipette with the antenna, but proton positions in the Pyrex tube differed in the approximately 2 mL (40 drops) of concentrated H₂SO₄ used for trials. Varying influences on the pipette and on drops thus were explained since the closer a decaying proton, the greater would be the imparting of energy creating influence. The unexpected force was named anti-gravity, calculated with a strength

$$α = \frac{4 π {ke}^{2}}{{E}_{photon} {λ}_{photon}} = 1 / 69 and a range e = \sqrt{\frac{α {E}_{photon} {λ}_{photon}}{4 π k}} \approx {10}^{- 19} C$$

suggesting equivalence to a quantized, repulsive charge. The negative sign in the above spin presentation indicates character with effect opposite to gravity. Anti-gravity and gravity are part of one Force equivalent emerging from the point of unification with the decrease in temperature. The repelling force is presented firstly since it appeared before observation of gravity.

Thoughts of skepticism with arguments of subjectivity led to verification of production of a force with an electronic probe (Team Labs®), the sensor tip against the Pyrex tube as the pipette had rested across from the antenna. With values recorded every second, a unique, suddenly significant increase as high as 0.019N from the previous reading was observed at the periodic times of drop falls and pipette movements. The increase was accepted noting production of a force and not a specific value describing a wave with spin-2.

Significant force readings occasionally maintained for 2-3 s appeared briefly apart at times that matched recordings of greatest drop falls and pipette movements, which suggested that protons could decay simultaneously in the Pyrex tube. By that, apart from the notion that closer productions of force to the pipette caused larger observations, the greater movements were due to multiple creations. Videlicet, the productions showed that protons positioned in-line could simultaneously decay being effective essentially from the same distance.

As to the enlarged Higgs field print of FIG. 9B, a photographic print was placed around the Pyrex tube for a trial of one hour and ten minutes in a darkroom. Presented is the portion of the print from the S pole region. Similar presentations were not on the print at the other directions illustrating concentrated proton attraction and subsequent decay, the markings not on prints from control trials as without the magnet or without the function generator on or at 2 Hz. Geiger counter and germanium detector readings confirmed radiations from decays.

The FIG. 9B labels point-out seemingly differing forms in the same area, a dark region surrounded by a weaker patch. The dark form is not apparent in the fainter other spots. In the hypothesis for the formation of gravity the reduced bodies combine, a means for stability. The coexistence prior to gravity is a unified Force equivalent in that the forces of Nature are one, which is understood with the reduced radio wave and reduced gluon being electroweak interaction and strong-weak interaction respectively. Thus, electroweak-strong interaction is likely the dual form in FIG. 9B.

The patches represent multiple productions as the print was around the Pyrex tube for an entire trial. The clumping does not prevent visualization of single reduced forms fusing. Time interval prints showed the dual form appearing at times coinciding drop falls, not at other moments, which limited possible causes.

Timing gives credibility to the dual presentation being due to the Higgs field especially since the two forms apparently have separate masses. In other words, prevalence of the field providing mass allowed the electroweak interaction to be captured on the paper. The more intense imprint 154 of the reduced gluon is indication of larger mass, thought result of containing the mediating Higgs boson. As mentioned, the unstable forms interacting and combining seemingly eliminated the Higgs field with release of Higgs boson and anti-Higgs boson energies, observed with no appearances on interval prints shortly after presence of the dual patches explaining why waves with spin-2 are massless. But from the union a wave with spin-2 has a characteristic energy, imparted manifesting as mass when interacting with objects allowing for space-time descriptions.

Imparting of mass was further confirmed in drop fall trials with multiple waves with spin-2 from set-ups distanced equally from the pipette as with FIG. 10, also confirming anti-gravity limitations. The additional waves caused corresponding fall distance and pipette movement increases: two waves→E=2 mc². The trials led to a Galilean conclusion of direct relation between number of waves with spin-2 (g) and time (t):

$$t \sim \sqrt{\frac{{g}^{2}}{2}} .$$

The relationship is better understood with a review of the discussion of FIG. 10.

FIG. 10 shows a two-magnet setup. Confusion may exist when considering

$$\sqrt{\frac{{g}^{2}}{2}}$$

since waves with spin-2 were expressed synonymously to gravity. More specifically, spin-2 waves are the property leading to the force manifesting from curved space-time. In other words, gravity resulting from the curvature of space-time is the mechanical expression of the force so that observed gravity, a ball falling to the ground, is equivalent to the acceleration of the object.

Explaining Newtonian concepts, imparted energy from waves with spin-2 creates unsteadiness. Attraction is an attempt to reduce the free energy to regain stability. Wave with spin-2 energy is lost over distance in accordance with 1/d², which was confirmed with force probe trials. More imparting of energy occurs to greater objects since more of a wave passes through. Since one wave with spin-2 with small electromagnetic energy of 1.05×10⁻²⁵ GeV was produced at a time in typical trials, the pipette and tube did not gain sufficient energy relative to existing masses of the objects to create sufficient instability to force sustained union because imparted energy was lost quickly explaining loss of attraction. Loss of attraction was also observed for drop movements: when incorporating water drop mass, mass-energy for one wave was ≈1.11×10³-1.11×10⁴ GeV considering minimum distance 0.0005 m between tube and pipette and typical distance 0.005 m from antenna to S pole tube wall. By that, after maintaining movement positions, the drops typically returned to or near prior locations being thought no longer influenced.

### Expression of the Higgs Boson

The following expresses the Higgs boson:

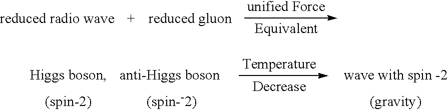

The Higgs boson possesses spin-0 as interval prints particularly presented nearly symmetrical appearances. Combining of the reduced forms made the boson spin-2 as with the antiparticle. Merging rendering the Higgs bodies unstable illuminates the notion of imparting of energy, with anti-Higgs boson energy release being responsible or equivalent to anti-gravity. Also, Higgs boson energy release likely produced elementary particles while imparting mass. The process of union and expression of the bosons therefore is suspected extremely rapid as observed by a Geiger counter reading with drop movements upward. And creation of the spin-2 Higgs boson presents the likelihood of five forms: spin-0 Higgs, spin-0 anti-Higgs, intermediate Higgs, spin-2 Higgs, spin-2 anti-Higgs.

### Primary Proton Decay Events

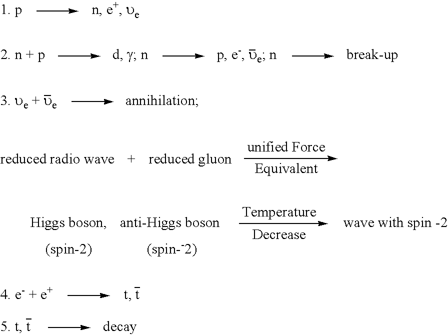

Above is a summary of the primary proton decay events. Three types of neutron activity occurred in the above-noted experiments and were observed with a germanium detector, the neutron break-up leading to a wave with spin-2. The positron and electron from proton and neutron decays respectively interacted and were visible with peaks 0.511 MeV and 1.026 MeV at times of drop falls and pipette movements or 1.04 MeV, slightly more than the typical 1.02 MeV for positron-electron annihilation. Additional energy resulted since the reaction can be imagined to have occurred just as Higgs boson energy was released. The sufficient energy available allowed quark pair production with the top (t) quark and antiparticle resulting due to decay propensity of the Higgs boson for the bodies. Because antiparticles are produced with the same mass, decay of the Higgs boson divided evenly to the top and anti-top quarks so that mass of the boson can be understood as twice the t quark mass 176 GeV/c²: E=2 mc²→2(176 GeV)=352 GeV. A more accurate calculation can be made when accepting the top quark to be unstable due to large mass in that observing decay of the particle provides a better defined value.

In terms of the creation of elementary particles, the following expression is instructive:

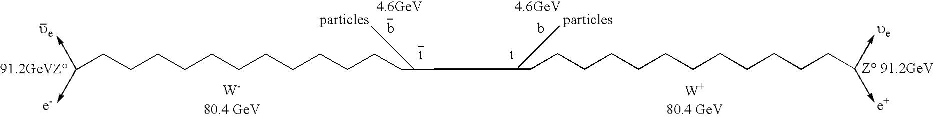

Adding masses of decay products b, \overline{b}, W⁺, W⁻, Z°, Z° provides the Higgs boson mass 352.4 GeV, which is in the range 115-420 GeV predicted at LEP and the Tevatron described by D. Demaree in the PowerPoint presentation The Higgs Boson. The bottom quarks (b) can lead to additional particles including decaying to lighter quarks. And though electron neutrinos are presented above, different forms can be observed after production.

Referring to the FIG. 8 single magnet set-up, H⁺ was produced by H₂SO₄+Cu→CuSO₄+2H⁺+2e⁻ in a Pyrex tube (No. 9825) with the insertion of 22-guage copper (solid, no tin, insulation stripped sufficiently at end) wire that was coiled at the tip 4-8 times. H⁺ was created by HCl+Cu→CuCl+H⁺e⁻ for controls. The electrons were removed from the tube by having the other exposed end of the wire embedded in the 100 mL container housing ≈400 grams of pulverized copper to sink≈1.875×10¹³ electrons per second that passed through the Cu bridge.

Observation of effect was thought the easiest method to observe production of gravity, which needed to be performed between the magnet poles to avoid the S pole as an obstruction. Water drops having small masses were concluded most useful and facile to introduce as with a pipette so that drop movements could be measured for calculations with vector addition. A Pasteur pipette was preferred being easily incorporated and allowing clear view of drop movements.

The Pyrex tube was tilted approximately five degrees to have the pipette initially as close as possible, i.e. ≈0.0005 m between the middle of the pipette and middle of the tube wall. Tilting did not alter results as observed in control trials with no tilt. And the tube typically was approximately 0.01 m from the S pole, note that being too close could cause drops not to fall due to over-influence from the magnet.

The pipette was filled with tap water with controls using H₂SO₄ so that drops would be apparent in the stem. The amount of water varied with the chief objective to stabilize a drop to be directly in-line with the antenna. Many drops were created in the stem initially since observations without the magnet showed drops tended to move upward. The magnet stabilized drops more quickly with a drop typically in place by 480 seconds. Inconsistencies arose when the pipette was not positioned well to allow a drop to be in-line with the antenna. Alignment was simplified with the portion of the tube containing the liquid and antenna being secured in-line with the middle of the S pole, indicated by a hole in the center of each pole. The average time 360 s for drop falls is not an exact assessment but was sufficient particularly for calculations since it reasonably described periodicity, particularly after 720 s when the first drop fall was usually noted.

### Higgs Field

Trials were conducted in a darkroom eliminating possibly affecting light to squares of Kodak Professional Kodabrome II RC F5 paper tapped around the tube as with FIG. 9A. Interval examinations involved holding pristine squares around the tube for minute periods during hour long trials or for briefer sessions. Capture of evidence of the field was improved when ensuring proton decay closer to the print paper by slightly reducing antenna distance.

Referring again to FIG. 10, a two-magnet experiment was described. Both magnets were separated in-line equally from the pipette. Drops were stable at the beginning of trials confirming previous observations that a magnet can hold drops in place. Trials using one magnet at the same distance from the pipette were performed, and data were invariant from one magnet examinations compared to additional trials with the FIG. 8 orientation maintaining the same pipette distance. Thus, the different magnet arrangement did not prevent H⁺ alignment and subsequent decay.

The set-up of FIG. 10 was the only means to produce and direct multiple waves with spin-2. Different tubes, ≈1.5 cm diameter and 6 cm circumference, were used since the Pyrex tube did not fit in the orientation. Incorporating the new tubes in the FIG. 8 set-up presented no data differences.

### Novel Application of Nuclei Decay: Producing New Elements

As will be further explained, the process of nuclei decay due to alignment in a magnetic field and interaction with cyclic electromagnetic energy can be used to restructure a nucleus. What is demonstrated below is the application of the subject technique that results in more energetic elements by addition to nuclei.

The machine used to achieve proton decay was modified to make certain that potential decays would occur well-placed in the H⁺ medium to allow for the creation of larger elements. The placement was achieved by increasing the length of the Hz antenna wire in the liquid of the Pyrex tube from typically approximately 0.7 cm to about 1.5 cm. The apparatus was left to run in front of a germanium detector to observe if larger elements were forming. Because the greatest radiation was suspected to be emitted toward the S pole, the detector tube face was placed as best as possible between the S pole and the Pyrex tube though placement would also have detected radiations emitted toward the detector tube more East of the apparatus.

As can be seen from FIG. 11B that depicts the results from greater Hz wire exposure, the counts are low because the machine could not be placed closer to the detector tube, which was 3-4 cm from the Pyrex tube and perpendicularly to the right (East) of the magnet. Also, the trial was run for the typical one hour with the usual small volume 2 mL so that high counts were not expected. Low counts were not limiting factors since use of the detector was simply to observe what nuclear activities occurred with proton decay and fusion. The most interesting peak is the 5.4 MeV peak that is release of energy in the creation of helium by the fusion of a proton (p) and a deuterium (d), d+p→³He, γ, which is the same fuel process as that of the Sun. The peak was not present in spectra from control trials as with less wire inserted in the tube or with the detector running without the machine nearby. The following set of expressions presents the progression of decay events to helium-3, understood from analyses of germanium detector graphs. The time consuming step in the process is the reduction of the proton.

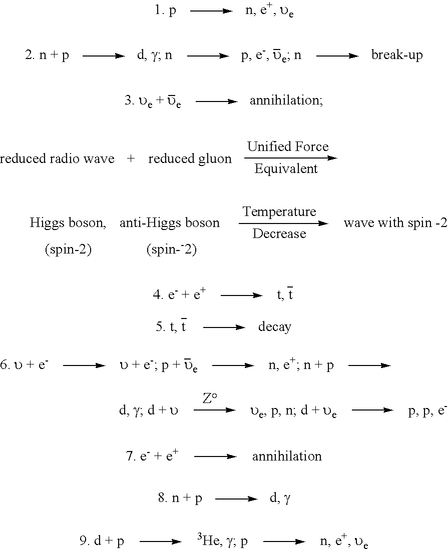

### Summary of Helium Formation

The formation of helium occurred because aligned protons in close proximity were being decayed by the 2 Hz (Vₚ₋ₚ≈12-12.5 V) electromagnetic waves from the antenna, though energy from a wave with spin-2 (gravity wave) could contribute to decay if encountering protons shortly after production. Also, radiation from decaying bodies could contribute to the decay of surrounding protons. However, such additional contributions should be remembered would not occur without at least one proton initially decaying from the influence of 2 Hz radio waves. To eliminate free energy for stability, decaying bodies fused due to close proximity in the Pyrex tube. Note that consideration was given to if the procedure could be applied to bodies with more stable nuclei as other elements on the periodic table.

Tungsten (W) powder was conveniently available and was thought would be well-suited for an experiment since the element is paramagnetic. The nucleus is highly stable when considering in addition to the high proton and neutron counts how innermost electrons in a tungsten atom are tightly bound to the nucleus allowing for a great deal of energy intake. Approximately 2 mg of W was added to H₂SO₄ volumes to be incorporated in the apparatus. Again, tungsten does not react with copper or with H₂SO₄ at room temperature so that the element was thought not to be affected by being swirled in the acid with the maintained set-up of FIG. 8.

H₂SO₄ volumes for W trials were raised to approximately 4 mL (80 drops) to increase the number of surrounding protons, which created more possibilities for combinations. The antenna was inserted to the bottom of the tube with the tip being immersed in any resting tungsten, and the trials were run for 5-6 hrs since possible decay of tungsten nuclei was considered would take longer. Also, for safety separation from the machine by a distance of about 4 m at an acute angle was taken since an enormous amount of radiation release was thought might occur. In fact, intense heat was felt during a trial that forced increased separation. The volumes after the trials were pooled since uncertainty existed regarding if fusion had occurred. Pooling was thought might increase the likelihood for observations in that individual volumes were considered might not be sufficiently concentrated with new elements to allow for readings from a detector.

Differential Thermal Analysis (DTA) with alumina powder as the reference was used to observe what elements existed in the collection. DTA is a simple method for determining compositions by recording melting points (m.p.) in that more than one element in a sample can be observed since each element has a different m.p. Thus, each peak or curve in the resulting spectra is individual and relative to others. The DTA machine could reach the maximum temperature of approximately 1200° C. Therefore, any observations would not be tungsten, which has a melting point of approximately 3422° C. Also, the machine was run with a temperature increase rate of 20° C./min, and 78.0 mg of the pooled sample was examined with the machine resulting in the presented graph of FIG. 12B.

Relating to the detected elements of FIG. 12B, comparing the peaks to runs of pure samples with melting points near the appearing peaks was used for identification particularly since what was created was considered synthetic in that that the peaks were thought might not have exact characteristics that would allow for identification with comparison to literature values. Also, prior to trials controls were run to calibrate the machine with success below 900° C. The limitation was not thought a significant problem if a pure sample would appear approximately at the same location as a peak, the case with a gold control and the peak labeled Au in FIG. 12B in that the control appeared near the location with the same peak structure. Thus, the other peaks could be additionally recognized relative to the gold peak. For instance, the peak labeled as astatine (At) was identified since it appeared near the 302° C. melting point literature value and only At has a significantly higher heat of fusion but a lower-melting point than Au.

The uranium (U) peak was identified similarly in that of the naturally occurring elements only U has a much lower heat of fusion and a melting point obviously larger but not significantly, greater than 20 degrees but less than 100 degrees, than gold. Other elements may have been produced including new elements not on the periodic table. The temperature range was limiting in that only At, Au, and U from tungsten are seen to have been produced.

The naturally occurring elements produced can be accepted as synthetic products of fusions when comparing heat of fusions to control sample measures. For example, the heat of fusion for the Au peak is only 22% of the control gold peak value because tungsten became unstable due to decay that involved the loss of elementary particles and radiation during the fusion process. The regaining of stability occurred by combining with nearby protons that created increases in proton number and the strong force. The result was the emerging of the new elements with respective melting points, atomic numbers, and heat of fusions. The radiation lost by W atoms was loss of energy or the strong force, further indication that the subject technology unifies the forces of Nature in that strong force is again expressed as decay and electromagnetic energy, so that though the larger elements were formed, less energy held them together. Thus, less energy was required to cause additional reduction for melting.

The data suggest clearly that the experimental method is an alternate technique for fusion as opposed to the procedure involving a high temperature environment as was used for the creation of the natural elements. In other words, the experiment was conducted at room temperature that allowed for energy loss as radiation to surroundings. In enormously high energy environments as during supernovae, internal energy of existing elements would be increased with a transfer of energy to the object similarly as described with the notion that heat flows naturally from regions of higher to areas of lower temperatures. The increase would create instability, as having occurred in the experiment, leading to a maintaining of order through fusion with the new elements having the typical, literature, higher heat of fusions.

The subject method of nuclei decay altering atomic structures is not limited to physical elements because in the subject technique, no heat input is required. Thus, the subject technique can be used for biological bodies or for engineering and laboratory purposes that may require the manipulation of or addition to structures. For example, the method may be applied in medicine for breaking bonds of diseased bodies or for altering structures and adding new components for desired results. The subject invention may be used to assist in treating diseases caused by altered nucleic acid structures in that the technique could be used to render faulty bodies ineffective or back to normal.

Having now described a few embodiments of the invention and some modifications and variations thereto, it should be apparent to those skilled in the art that the foregoing is merely illustrative and not limiting, having been presented by way of examples only. Numerous modifications and other embodiments are within the range of one of ordinary skill in the art and are contemplated as falling within the scope of the invention as limited only by the appended claims and equivalents thereto.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. A method for the production of energy, comprising the steps of:
placing nuclei in a magnetic field;
maintaining the nuclei at room temperature; and,
subjecting the nuclei to extreme low frequency periodic radiation from an antenna adjacent the nuclei.

2. The method of claim 1, wherein the nuclei include protons.

3. The method of claim 2, wherein the low frequency is between 1 and 3 Hz.

4. The method of claim 2, wherein the low frequency is 2 Hz.

5. The method of claim 1, wherein the production of energy is from a room temperature fusion process involving subjecting a proton and another element to the extreme low frequency radiation in the presence of the magnetic field.

6. The method of claim 1, wherein the production of energy is from the room temperature production of a gravity wave.

7. The method of claim 1, wherein the production of energy is from particle-antiparticle annihilation.

8. A room temperature method of causing the decay of a proton, comprising the steps of:
locating a proton in a magnetic field; and,
subjecting the proton when in the magnetic field to a 2 Hz wave from an antenna proximate to the proton, whereby the proton can be made to decay in seconds.

9. The method of claim 8, wherein the 2 Hz wave has an amplitude in the tens of volts.

10. A method of producing a gravity wave, comprising the steps of:
locating a proton in a magnetic field; and,
subjecting the proton when in the magnetic field to a 2 Hz wave from an antenna proximate to the proton, whereby the decay of the proton to a neutron, a positron and an electron neutrino results in the generation of the gravity wave.

11. A method of producing room temperature fusion, comprising the step of:
subjecting a proton and another element to a 2 Hz wave from an antenna in the presence of a magnetic field, whereby proton decay results in the production of a third element.

12. A method of creating particle-antiparticle annihilation, comprising the step of:
subjecting a proton to a 1-3 Hz signal from an antenna adjacent the proton with the proton placed in a magnetic field.

13. Apparatus for generating energy comprising:
a magnetic field;
a proton in said magnetic field;
an antenna adjacent said proton; and,
a source of 1-3 Hz energy coupled to said antenna, whereby said generated energy is the result of the decay of said proton.

14. The apparatus of claim 13, wherein said proton is created from a volume of H₂SO₄, a wire having an end in said H₂SO₄ and a copper sink coupled to the other end of said wire.

15. The apparatus of claim 13, wherein said magnetic field is at least 2000 gauss.

16. The apparatus of claim 13, wherein the magnitude of said 1-3 Hz energy is between 12 and 12.5 volts.
